(19) United States
(12) Patent Application Publication
(10) Pub. No.: US 2006/0066589 A1
(43) Pub. Date: Mar. 30, 2006

(54) Input device

(76) Inventors: Masanori Ozawa, Kawasaki-shi (JP); Katsumi Hisano, Matsudo-shi (JP); Ryo Furukawa, Kawasaki-shi (JP); Minoru Mukai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/233,072

(22) Filed: Sep. 23, 2005

(30) Foreign Application Priority Data
Sep. 29, 2004 (JP) P2004-285445

(51) Int. Cl. G09G 5/00

(52) U.S. Cl. 345/173

(57) ABSTRACT

An input device includes: a display unit indicating an image of an input position; a contact position detecting unit detecting a position of an object brought into contact with a contact detecting layer provided on a display layer of the display unit; a contact strength detecting unit detecting contact strength of the object brought into contact with the contact detecting layer; a feature quantity extracting unit extracting a feature quantity related to the detected contact strength; and a special process executing unit comparing the extracted feature quantity with a predetermined threshold, and executing special processes.

### CROSS REFERENCE TO RELATED APPLICATIONS

This application is based upon and claims the benefit of priority from prior Japanese Patent Application 2004-285445 filed on Sep. 29, 2004; the entire contents of which are incorporated by reference herein.

### BACKGROUND OF THE INVENTION

1. Field of the Invention

The present invention relates to an input device which feeds information into a computer or the like, a computer provided with the input device, and information processing method and program.

2. Description of the Related Art

Usually, an interface for a computer terminal includes a keyboard and a mouse as an input device, and a cathode ray tube (CRT) or a liquid crystal display (LCD) as a display unit.

Further, so-called touch panels in which a display unit and an input device are laminated one over another are in wide use as interfaces for computer terminals, small portable tablet type calculators, and so on.

Japanese Patent Laid-Open Publication No. 2003-196,007 discloses a touch panel used to enter characters into a portable phone or a personal digital assistant (PDA) which has a small front surface.

Up to now, it is however very difficult to know whether an object such as a user's finger or an input pen is simply placed on a touch panel or whether the touch panel is depressed by such an object. This tends to lead to input errors.

The present invention is aimed at overcoming the foregoing problem of the related art, and provides an input device which can appropriately detect a contact state of an input device, a computer including such an input device, and information processing method and program.

### BRIEF SUMMARY OF THE INVENTION

According to a first aspect of the embodiment of the invention, there is provided an input device including: a display unit indicating an image of an input position; a contact position detecting unit detecting a position of an object brought into contact with a contact detecting layer provided on a display layer of the display unit; a contact strength detecting unit detecting contact strength of the object brought into contact with the contact detecting layer; a feature quantity extracting unit extracting a feature quantity related to the detected contact strength; and an special process executing unit comparing the extracted feature quantity with a predetermined threshold, and executing special processes.

In accordance with a second aspect, there is provided a microcomputer including: a display unit indicating an image of an input position; a contact position detecting unit detecting a position of an object brought into contact with a contact detecting layer provided on a display layer of the display unit; a contact strength detecting unit detecting contact strength of the object brought into contact with the contact detecting layer; a feature quantity extracting unit extracting a feature quantity related to the detected contact strength; and a special process executing unit comparing the extracted feature quantity with a predetermined threshold, and executing special processes.

According to a third aspect, there is provided an information processing method including: indicating an image of an input position on a display unit; detecting a contact position of an object in contact with a contact detecting layer of the display unit; detecting contact strength of the object; extracting a feature quantity related to the detected contact strength; and comparing the extracted feature quantity with a predetermined threshold and executing special processes on the basis of the compared result.

According to a final aspect, there is provided an information processing program including: indicating an image of an input position on a display unit; detecting a contact position of an object in contact with a contact detecting layer of the display unit; detecting contact strength of the object; extracting a feature quantity related to the detected contact strength; and comparing the extracted feature quantity with a predetermined threshold and executing special processes on the basis of the compared result.

### BRIEF DESCRIPTION OF THE SEVERAL VIEWS THE DRAWINGS

FIG. 1 is a perspective view of a portable microcomputer according to a first embodiment of the invention;

FIG. 2 is a perspective view of an input section of the portable microcomputer;

FIG. 3A is a perspective view of a touch panel of the portable microcomputer;

FIG. 3B is a top plan view of the touch panel of FIG. 3A;

FIG. 3C is a cross section of the touch panel of FIG. 3A;

FIG. 4 is a block diagram showing a configuration of an input device of the portable microcomputer;

FIG. 5 is a block diagram of the portable microcomputer;

FIG. 6 is a graph showing variations of a size of a contact area of an object brought into contact with the touch panel;

FIG. 7 is a graph showing variation of a size of a contact area of an object brought into contact with the touch panel in order to enter information;

FIG. 8A is a perspective view of a touch panel converting pressure into an electric signal;

FIG. 8B is a top plan view of the touch panel shown in FIG. 8A;

FIG. 8C is a cross section of the touch panel;

FIG. 9 is a schematic diagram showing the arrangement of contact detectors of the touch panel;

FIG. 10 is a schematic diagram showing contact detectors detected when they are pushed by a mild pressure;

FIG. 11 is a schematic diagram showing contact detectors detected when they are pushed by an intermediate pressure;

FIG. 12 is a schematic diagram showing contact detectors detected when they are pushed by an intermediate pressure;

FIG. 13 is a schematic diagram showing contact detectors detected when they are pushed by a large pressure;

FIG. 14 is a schematic diagram showing contact detectors detected when they are pushed by a largest pressure;

FIG. 15 is a perspective view of a lower housing of the portable microcomputer;

FIG. 16 is a top plan view of an input device of the portable microcomputer, showing that user's palms are placed on the input device in order to enter information;

FIG. 17 is a top plan view of the input device, showing that the user's fingers hit keys;

FIG. 18 is a flowchart of information processing steps conducted by the input device;

FIG. 19 is a flowchart showing details of step S106 shown in FIG. 18;

FIG. 20 is a flowchart of further information processing steps conducted by the input device;

FIG. 21 is a flowchart showing details of step S210 shown in FIG. 20;

FIG. 22 shows hit section of a key top of the input device;

FIG. 23 shows a further example of hit section of the key top of the input device;

FIG. 24 is a flowchart showing a user authentication process;

FIG. 25 is a flowchart showing details of step S502 in FIG. 24;

FIG. 26 shows a size of a contact area A;

FIG. 27A is a graph showing variations of a size of the contact area when an object remains on a key;

FIG. 27B is a graph showing variations of a size of the contact area when a key is hit;

FIG. 28 is a flow chart showing a device protecting process;

FIG. 29 is a flowchart showing a user protecting process;

FIG. 30 is a flowchart showing a key shifting process;

FIG. 31 is a perspective view of an input device in further embodiment;

FIG. 32 is a block diagram of an input device in a still further embodiment;

FIG. 33 is a block diagram of a still further embodiment;

FIG. 34 is a block diagram of a still further embodiment; and

FIG. 35 is a perspective view of a touch panel in a further embodiment.

### DETAILED DESCRIPTION OF THE INVENTION

Various embodiments of the present invention will be described with reference to the drawings. It is to be noted that the same or similar reference numerals are applied to the same or similar parts and elements throughout the drawings, and the description of the same or similar parts and element will be omitted or simplified.

### First Embodiment

In this embodiment, the invention relates to an input device, which is a kind of an input-output device of a terminal unit for a computer.

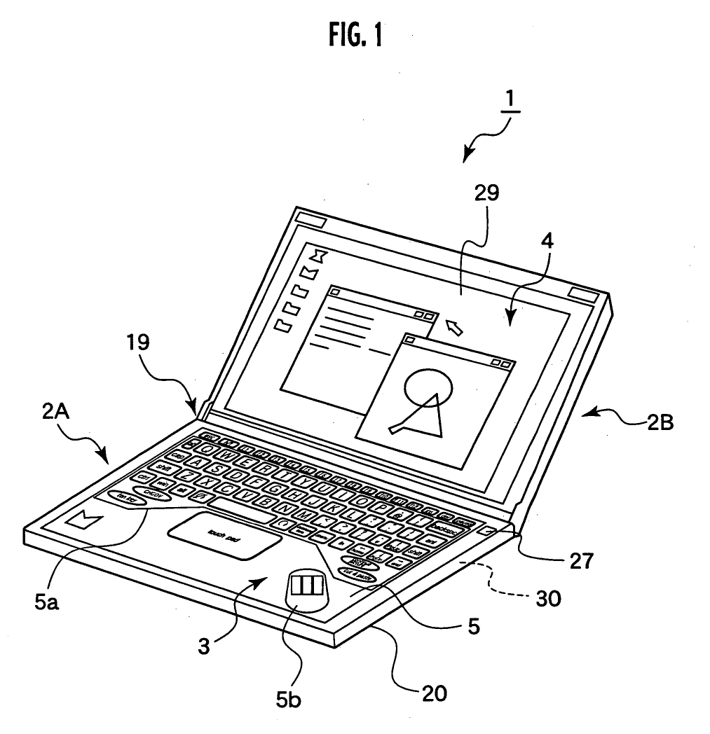

Referring to FIG. 1, a portable microcomputer 1 (called the “microcomputer 1”) includes a computer main unit 30, a lower housing 2A and an upper housing 2B. The computer main unit 30 includes an arithmetic and logic unit such as a central processing unit. The lower housing 2A houses an input unit 3 as a user interface for the computer main unit 30. The upper housing 2B houses a display unit 4 with a liquid crystal display panel 29 (called the “display panel 29”).

The computer main unit 30 uses the central processing unit in order to process information received via the input unit 3. The processed information is indicated on the display unit 4 in the upper housing 2B.

The input unit 3 in the lower housing 2A includes a display unit 5, and a detecting unit which detects a contact state of an object (such as a user's finger or an input pen) onto a display panel of the display unit 5, and indicates images representing a virtual keyboard 5a, keys, a virtual mouse 5b and so on used to input information.

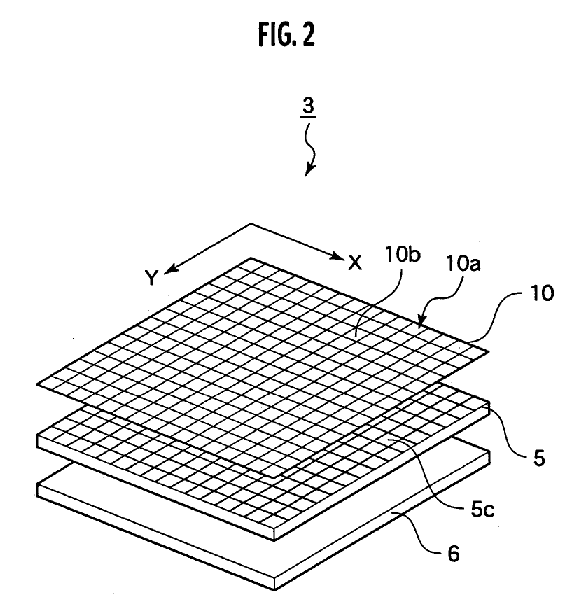

The input unit 3 further includes a backlight 6 having a light emitting area, and a touch panel 10 laminated on the display unit 5, as shown in FIG. 2. Specifically, the display unit 5 is laminated on the light emitting area of the backlight 6

The backlight 6 may be constituted by a combination of a fluorescent tube and an optical waveguide which is widely used for displays of microcomputers, or may be realized by a plurality of white light emitting diodes (LED) arranged on the flat. Such LED have been recently put to practical use.

Both the backlight 6 and the display unit 5 may be structured similarly to those used for display units of conventional microcomputers or those of external LCD displays for desktop computers. If the display unit 5 is light emitting type, the backlight 6 may be omitted.

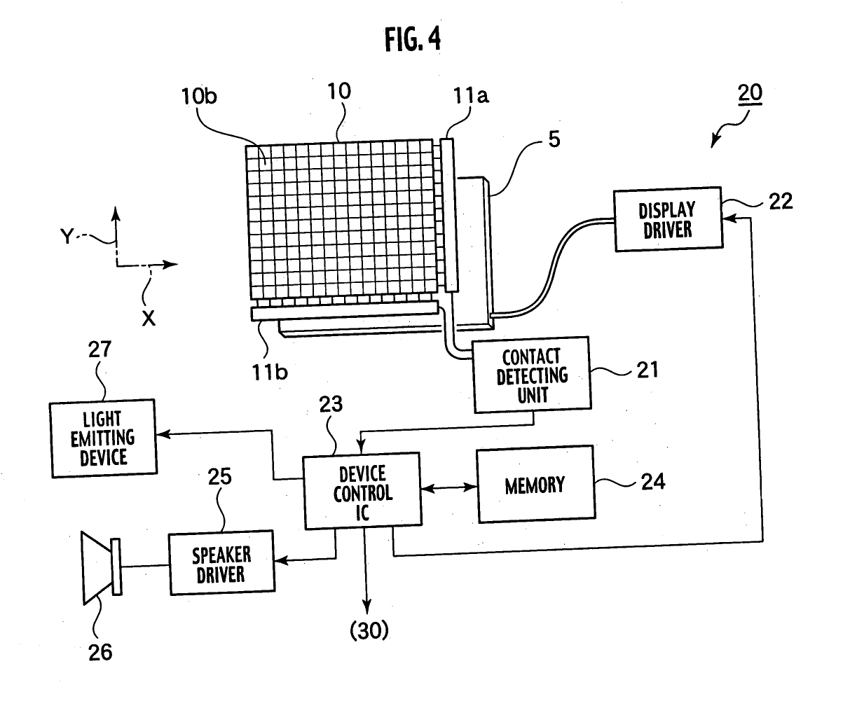

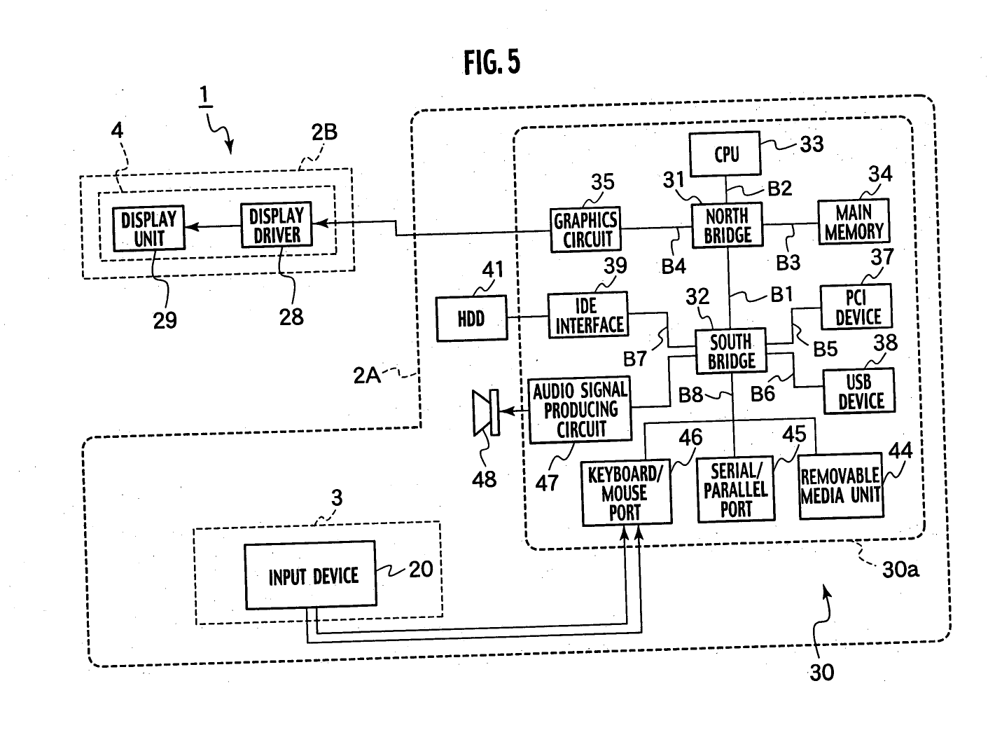

The display unit 5 includes a plurality of pixels 5c arranged in x and y directions and in the shape of a matrix, is actuated by a display driver 22 (shown in FIG. 4), and indicates an image of the input position such as the keyboard or the like.

The touch panel 10 is at the top layer of the input unit 3, is exposed on the lower housing 2A, and is actuated in order to receive information. The touch panel 10 detects an object (the user's finger or input pen) which is brought into contact with a detecting layer 10a.

In the first embodiment, the touch panel 10 is of a resistance film type. Analog and digital resistance film type touch panels are available at present. Four- to eight-wire type analog touch panels are in use. Basically, parallel electrodes are utilized, a potential of a point where the object comes into contact with an electrode is detected, and coordinates of the contact point are derived on the basis of the detected potential. The parallel electrodes are independently stacked in X and Y directions, which enables X and Y coordinates of the contact point to be detected. However, with the analog type, it is very difficult to simultaneously detect a number of contact points. Further, the analog touch panel is inappropriate for detecting dimensions of contact areas. Therefore, the digital touch panel is utilized in the first embodiment in order to detect both the contact points and dimensions of the contact areas. In any case, the contact detecting layer 10a is transparent, so that the display unit 5 is visible from the front side.

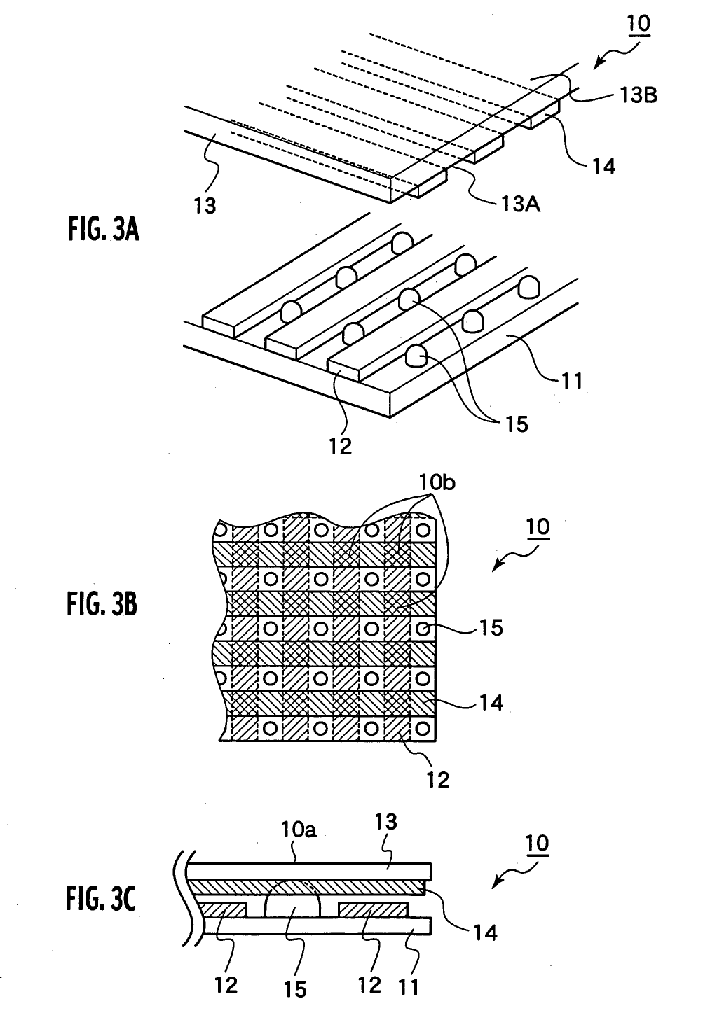

Referring to FIGS. 3A and 3B, the touch panel 10 includes a base 11 and a base 13. The base 11 includes a plurality (n) of strip-shaped X electrodes 12 which are arranged at regular intervals in the X direction. On the other hand, the base 13 includes a plurality (m) of strip-shaped Y electrodes 14 which are arranged at regular intervals in the Y direction. The bases 11 and 13 are stacked with their electrodes facing with one another. In short, the X electrodes 12 and Y electrodes 14 are orthogonal to one another. Therefore, (n×m) contact detectors 10b are arranged in the shape of a matrix at the intersections of the X electrodes 12 and Y electrodes 14.

A number of convex-curved dot spacers 15 are provided between the X electrodes on the base 11. The dot spacers 15 are made of an insulating material, and are arranged at regular intervals. The dot spacers 15 have a height which is larger than a total of thickness of the X and Y electrodes 12 and 14. The dot spacers 15 have their tops brought into contact with exposed areas 13A of the base 13 between the Y electrodes 14. As shown in FIG. 3C, the dot spacers 15 are sandwiched by the bases 11 and 13, and are not in contact with the X and Y electrodes 12 and 14. In short, the X and Y electrodes 12 and 14 are out of contact with one another by the dot spacers 15. When the base 13 is pushed in the foregoing state, the X and Y electrodes 12 and 14 are brought into contact with one another.

A surface 13B of the base 13, opposite to the surface where the Y electrodes are mounted, is exposed on the lower housing 2A, and is used to enter information. In other words, when the surface 13B is pressed by the user's finger or the input pen, the Y electrode 14 is brought into contact with the X electrode 12.

If a pressure applied by the user's finger or input pen is equal to or less than a predetermined pressure, the base 13 is not sufficiently flexed, which prevents the Y electrode 14 and the X electrode 12 from being brought into contact with each other. Only when the applied pressure is above the predetermined value, the base 13 is fully flexed, so that the Y electrode 14 and the X electrode 12 are in contact with each other and become conductive.

The contact points of the Y and X electrodes 14 and 12 are detected by the contact detecting unit 21 (shown in FIG. 4) of the input unit 3.

With the microcomputer 1, the lower housing 2A houses not only the input unit 3 but also the input device 20 which includes contact detecting unit 21 detecting contact points of the X and Y electrodes 12 and 14 of the touch panel 10.

Referring to FIG. 2 and FIG. 4, the input device 20 includes the input unit 3, the contact detecting unit 21, a device control IC 23, a memory 24, a speaker driver 25, and a speaker 26. The device control IC 23 converts the detected contact position data into digital signals and performs I/O control related to various kinds of processing (to be described later), and communications to and from the computer main unit 30. The speaker driver 25 and speaker 26 are used to issue various verbal notices or a beep sound for notice.

The contact detecting unit 21 applies a voltage to the X electrodes 12 one after another, measures voltages at the Y electrodes 14, and detects a particular Y electrode 14 which produces a voltage equal to the voltage applied to the X electrodes.

The touch panel 10 includes a voltage applying unit 11a, which is constituted by a power source and a switch part. In response to an electrode selecting signal from the contact detecting unit 21, the switch part sequentially selects X electrodes 12, and the voltage applying unit 11a applies the reference voltage to the selected X electrodes 12 from the power source.

Further, the touch panel 10 includes a voltage meter 11b, which selectively measures voltages of Y electrodes 14 specified by electrode selecting signals from the contact detecting unit 21, and returns measured results to the contact detecting unit 21.

When the touch panel 10 is pressed by the user's finger or input pen, the X and Y electrodes 12 and 14 at the pressed position come into contact with each other, and become conductive. The reference voltage applied to the X electrode 12 is measured via the Y electrode 14 where the touch panel 10 is pressed. Therefore, when the reference voltage is detected as an output voltage of the Y electrode 14, the contact detecting unit 21 can identify the Y electrode 14, and the X electrode 12 which is applied the reference voltage. Further, the contact detecting unit 21 can identify the contact detector 10b which has been pressed by the user's finger or input pen on the basis of a combination of the X electrode 12 and Y electrode 14.

The contact detecting unit 21 repeatedly and quickly detects contact states of the X and Y electrodes 12 and 14, and accurately detects a number of the X and Y electrodes 12 and 14 which are simultaneously pressed, depending upon arranged intervals of the X and Y electrodes 12 and 14.

For instance, if the touch panel 20 is strongly pressed by the user's finger, a contact area is enlarged. The enlarged contact area means that a number of contact detectors 10b are pressed. In such a case, the contact detecting unit 21 repeatedly and quickly applies the reference voltage to X electrodes 12, and repeatedly and quickly measures voltages at Y electrodes 14. Hence, it is possible to detect the contact detectors 10b pressed at a time. The contact detecting unit 21 can detect a size of the contact area on the basis of detected contact detectors 10b.

In response to a command from the device control IC 23, the display driver 22 indicates one or more images of buttons, icons, keyboard, ten-keypad, mouse and so on which are used as input devices, i.e., user's interface. Light emitted by the backlight 6 passes through the LCD from a back side thereof, so that the images on the display unit 5 can be observed from the front side.

The device control IC 23 identifies an image of the key at the contact point on the basis of a key position on the virtual keyboard (indicated on the display unit 5) and the contact position and a contact area detected by the contact detecting unit 21. Information on the identified key is notified to the computer main unit 30.

The computer main unit 30 controls operations for the information received from the device control IC 23.

Referring to FIG. 5, in a motherboard 30a (functioning as the computer main unit 30), a north bridge 31 and a south bridge 32 are connected using a dedicated high speed bus B1. The north bridge 31 connects to a central processing unit 33 (called the “CPU 33”) via a system bus B2, and to a main memory 34 via a memory bus B3, and to a graphics circuit 35 via an accelerated graphics port bus B4 (called the “AGP bus B4”).

The graphics circuit 35 outputs a digital image signal to a display driver 28 of the display panel 4 in the upper housing 2B. In response to the received signal, the display driver 28 actuates the display panel 29. The display panel 29 indicates an image on a display panel (LCD) thereof.

Further, the south bridge 32 connects to a peripheral component interconnect device 37 (called the “PCI device 37”) via a PCI bus B5, and to a universal serial bus device 38 (called the “USB device 38”) via a USB bus B6.

The south bridge 32 can connect a variety of units to the PCI bus 35 via the PCI device 37, and connect various units to the USB device 38 via the USB bus B6.

Still further, the south bridge 32 connects to a hard disc drive 41 (called the “HDD 41”) via an integrated drive electronics interface 39 (called the “IDE interface 39”) and via an AT attachment bus B7 (called the “ATA bus 37”). In addition, the south bridge 32 connects via a low pin count bus B8 (called the “LCP bus B8”) to a removable media device (magnetic disc device) 44, a serial/parallel port 45 and a keyboard/mouse port 46. The keyboard/mouse port 46 provides the south bridge 32 with a signal received from the input device 20 and indicating the operation of the keyboard or the mouse. Hence, the signal is transferred to the CPU 33 via the north bridge 31. The CPU 33 performs processing in response to the received signal.

The south bridge 32 also connects to an audio signal output circuit 47 via a dedicated bus. The audio signal output circuit 47 provides an audio signal to a speaker 48 housed in the computer main unit 30. Hence, the speaker 48 outputs variety of sounds.

The CPU 33 executes various programs stored in the HDD 41 and the main memory 34, so that images are shown on the display panel 29 of the display unit 4 (in the upper housing 2B), and sounds are output via the speaker 48 (in the lower housing 2A). Thereafter, the CPU 33 executes operations in accordance with the signal indicating the operation of the keyboard or the mouse from the input device 20. Specifically, the CPU 33 controls the graphics circuit 35 in response to the signal concerning the operation of the keyboard or the mouse. Hence, the graphics circuit 35 outputs a digital image signal to the display unit 5, which indicates an image corresponding to the operation of the keyboard or the mouse. Further, the CPU 33, controls the audio signal output circuit 47, which provides an audio signal to the speaker 48. The speaker 48 outputs sounds indicating the operation of the keyboard or the mouse.

The following describe how the input device 20 operates in order to detect contact states of the finger or input pen on the contact detecting layer 10a.

The contact detecting unit 21 (as a contact position detector) periodically detects a position where the object is in contact with the contact detecting layer 10a of the touch panel 10, and provides the device control IC 23 with the detected results.

The contact detecting unit 21 (as a contact strength detector) detects contact strength of the object on the contact detecting layer 10a. The contact strength may be represented by two, three or more discontinuous values or a continuous value. The contact detecting unit 21 periodically provides the device control IC 23 with the detected strength.

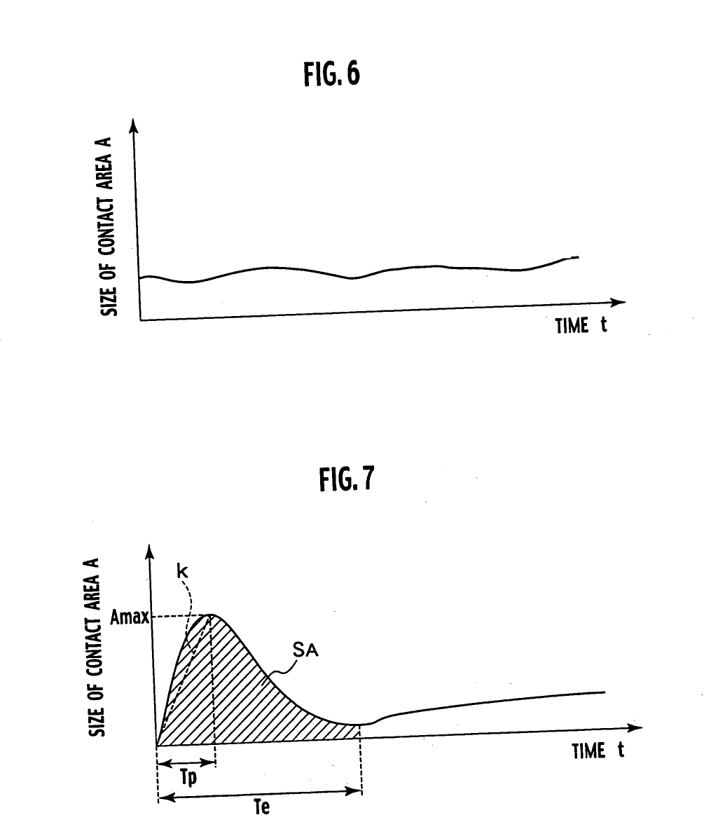

The contact strength can be detected on the basis of the sizes of the contact area of the object on the contact detecting layer 10a, or time-dependent variations of the contact area. FIG. 6 and FIG. 7 show variations of sizes of the detected contact area. In these figures, the ordinate and abscissa are dimensionless, and neither units nor scales are shown. Actual values may be used at the time of designing the actual products.

The variations of the contact area will be derived by periodically detecting data on the sizes of contacts between the object and the contact detector 10b using a predetermined scanning frequency. The higher the scanning frequency, the more signals will be detected in a predetermined time period. Resolutions can be more accurately improved with time. For this purpose, reaction speeds and performance of the devices and processing circuits have to be improved. Therefore, an appropriate scanning frequency will be adopted.

Specifically, FIG. 6 shows an example in which the object is simply in contact with the contact detecting layer 10a, i.e. the user simply places his or her finger without aim to key. The size of the contact area A do not change sharply.

On the contrary, FIG. 7 shows another example in which a size of the contact area A varies when a key is hit on the keyboard on the touch panel 10. In this case, the size of the contact area A is quickly increased from 0 or substantially 0 to a maximum, and then quickly is reduced.

The contact strength may be detected on the basis of a contact pressure of the object onto the contact detecting layer 10a, or time-dependent variations of the contact pressure. In this case, a sensor converting the pressure into an electric signal may be used as the contact detecting layer 10a.

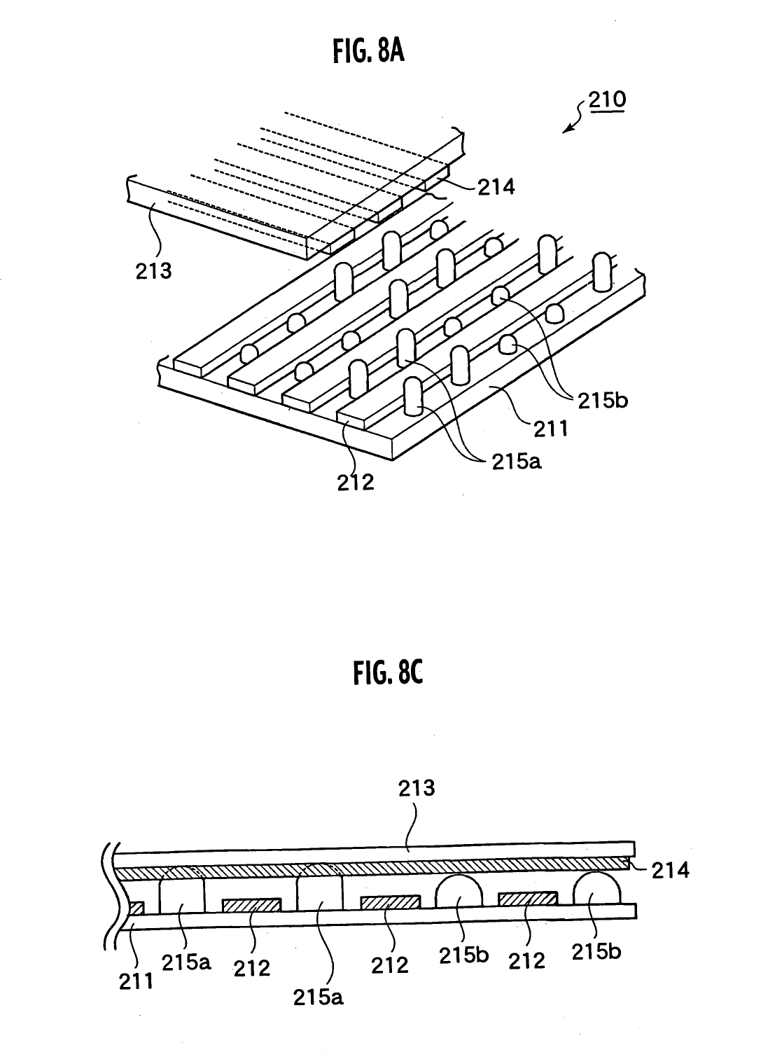

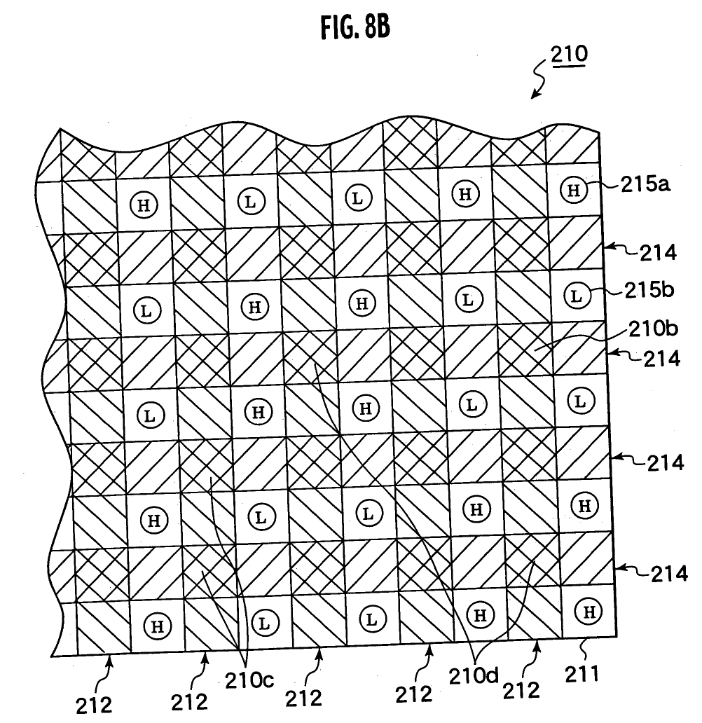

FIG. 8A and FIG. 8B show a touch panel 210 as a sensor converting the pressure into an electric signal (called a contact strength detector).

Referring to these figures, the touch panel 210 includes a base 211 and a base 213. The base 211 is provided with a plurality of (i.e., n) transparent electrode strips 212 serving as X electrodes (called the “X electrodes 212”) and equally spaced in the direction X. The base 213 is provided with a plurality of (i.e., m) transparent electrode strips 214 serving as Y electrodes (called the “Y electrodes 214”) and equally spaced in the direction Y. The bases 211 and 213 are stacked with the X and Y electrodes 212 and 214 facing one another. Hence, (n×m) contact detectors 210b to 210d are present in the shape of a matrix at intersections of the X and Y electrodes 212 and 214.

Further, a plurality of convex spacers 215 are provided between the X electrodes 212 on the base 211, and have a height which is larger than a total thickness of the X and Y electrodes 212 and 214. The tops of the convex spacers 215 are in contact with the base 213 exposed between the Y electrodes 214.

Referring to FIG. 8A, in a dot spacer 215, four tall dot spacers 215a constitute one group, and four short dot spacers 215b constitute one group. Groups of the four tall dot spacers 215a and groups of the four short dot spacers 215b are arranged in a reticular pattern, as shown in FIG. 8B. The number of toll dot spacers 215a per group and that of short dot spacers 215b per group can be determined as desired.

Referring to FIG. 8C, the dot spacers 215 are sandwiched between the bases 211 and 213. Hence, X and Y electrodes 212 and 214 are not in contact with one another. Therefore, the contact detectors 210b to 210e are electrically in an off-state.

The X and Y electrodes 212 and 214 are in an on-state when the base 213 is flexed while the foregoing electrodes are not in contact with one another.

With the touch panel 210, the surface 213A which is opposite to the surface of the base 213 where the Y electrodes 214 are positioned is exposed as an input surface. When the surface 213A is pressed by the user's finger, the base 213 is flexed, thereby bringing the Y electrode 214 into contact with the X electrode 212.

If pressure applied by the user's finger is equal to or less than a first predetermined pressure, the base 213 is not sufficiently flexed, which prevents the X and Y electrodes 214 and 212 from coming into contact with each other.

Conversely, when the applied pressure is above the first predetermined pressure, the base 213 is sufficiently flexed, so that a contact detector 210b surrounded by four low dot spacers 215b (which are adjacent to one another without via the Y and X electrodes 214 and 212) remains in the on-state. The contact detectors 210c and 210d surrounded by two or more high dot spacers 215a remain in the off-state.

If the applied pressure is larger than a second predetermined pressure, the base 213 is further flexed, the contact detector 210c surrounded by two low dot spacers 215b is in the on-state. However, the contact detector 210d surrounded by four high dot spacers 215a remain in the off-state.

Further, if the applied pressure is larger than a third predetermined pressure which is larger than the second pressure, the base 213 is more extensively flexed, so that the contact detector 210d surrounded by four high dot spacers 215a is in the on-state.

The three contact detectors 210b to 210d are present in the area pressed by the user's finger, and function as sensors converting the detected pressures into three kinds of electric signals.

With the portable microcomputer including the touch panel 210, the contact detecting unit 21 detects which contact detector is in the on-state.

For instance, the contact detecting unit 21 detects a contact detector, which is existing in center of a group of adjacent contact detectors in the on-state, as a position where the contact detecting surface 10a is pressed.

Further, the contact detecting unit 21 ranks the contact detectors 210b to 210d in three grades, and a largest grade is output as pressure, among a group of adjacent contact detectors in the on-state.

The contact detecting unit 21 detects a contact area and pressure distribution as follows.

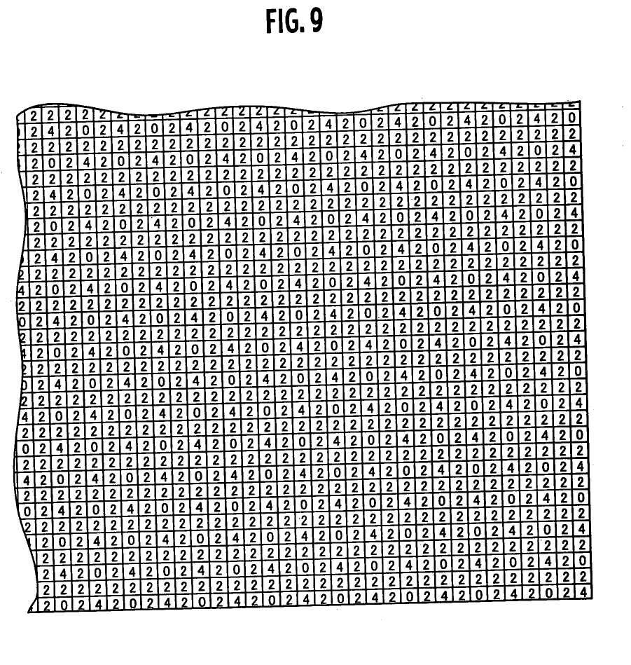

When the low and high dot spacers 215b and 215a shown in FIG. 8B are arranged as shown in FIG. 9, each contact detector 210 is surrounded by four dot spacers. In FIG. 9, numerals represent the number of the high dot spacers 215a at positions corresponding to the contact detectors 210a to 210d.

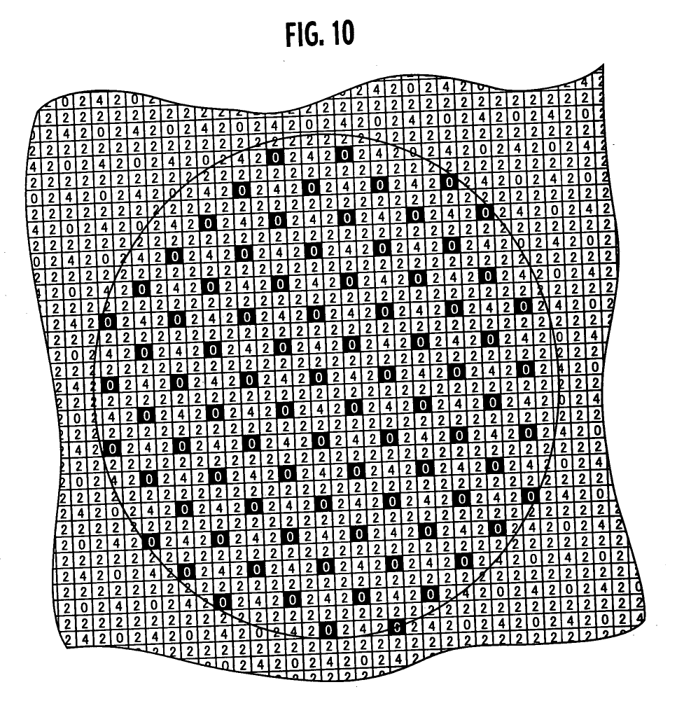

In FIG. 10, an oval shows an area contacted by the user's finger, and is called the “outer oval”.

When a surface pressure of the contact area (i.e., pressure per unit area) is simply enough to press contact detectors shown by “0”, the contact detecting unit 21 detects that only contact detectors “0” (i.e., the contact detectors 210b shown in FIG. 8B) are pressed.

If much stronger pressure is applied to an area whose size is the same as that of the outer oval compared to the pressure shown in FIG. 9, the contact detecting unit 21 detects contact detectors “2” existing in an oval inside (called the “inner oval”) the outer oval, i.e., contact detectors 210c shown in FIG. 8B are pressed.

The larger the pressure, the larger the outer oval as described with reference to the operation principle of the embodiment. However, it is assumed that the outer oval has a constant size for explaining easily.

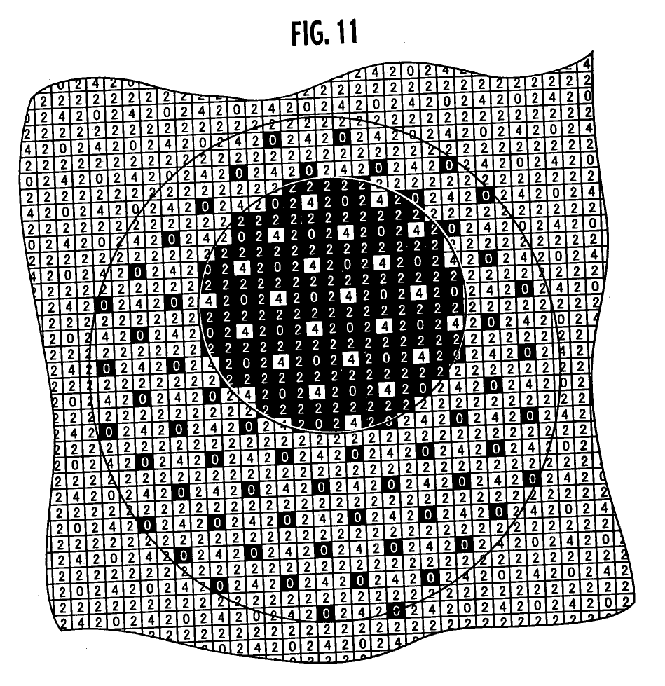

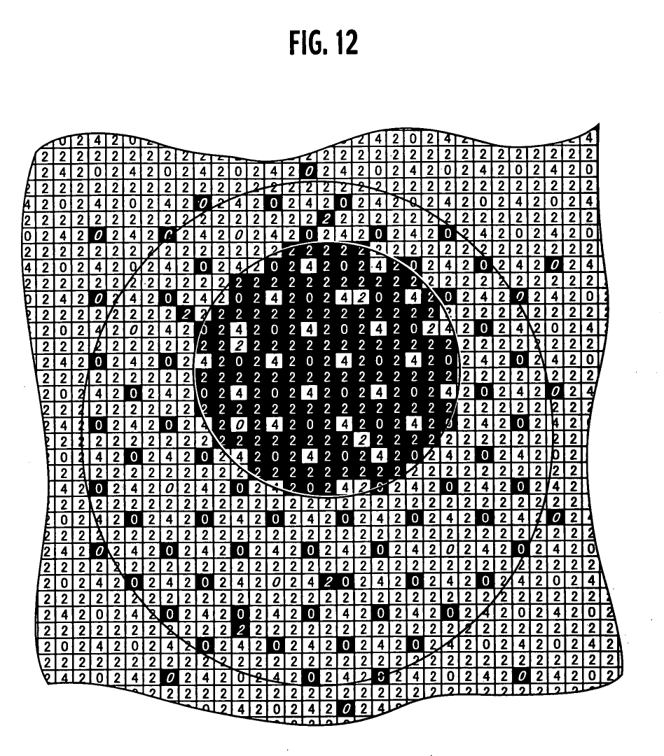

However, the surface pressure is not always actually distributed in the shape of an oval as shown in FIG. 11. In FIG. 12, some contact detectors outside the outer oval may be detected to be pressed, and some contact detectors “0” or “2” inside the inner oval may not be detected to be pressed. Those exceptions are described in italic digits in FIG. 12. In short, contact detectors “0” and “2” are mixed near a border of the outer and inner ovals. The border, size, shape or position of the outer and inner ovals are determined so as to reduce errors caused by these factors. In such a case, the border of the outer and inner ovals may be complicated in order to assure flexibility. However, the border is actually shaped with an appropriate radius of curvature. This enables the border to have a smoothly varying contour and is relatively free from errors. The radius of curvature determined through experiments, machine learning algorithm or the like. Objective functions are a size of an area surrounded by the outer oval and inner oval at the time of keying, a size of an area surrounded by the inner oval and an innermost oval, and a time-dependent keying identifying error rate. A minimum the radius of curvature is determined in order to minimize the foregoing parameters.

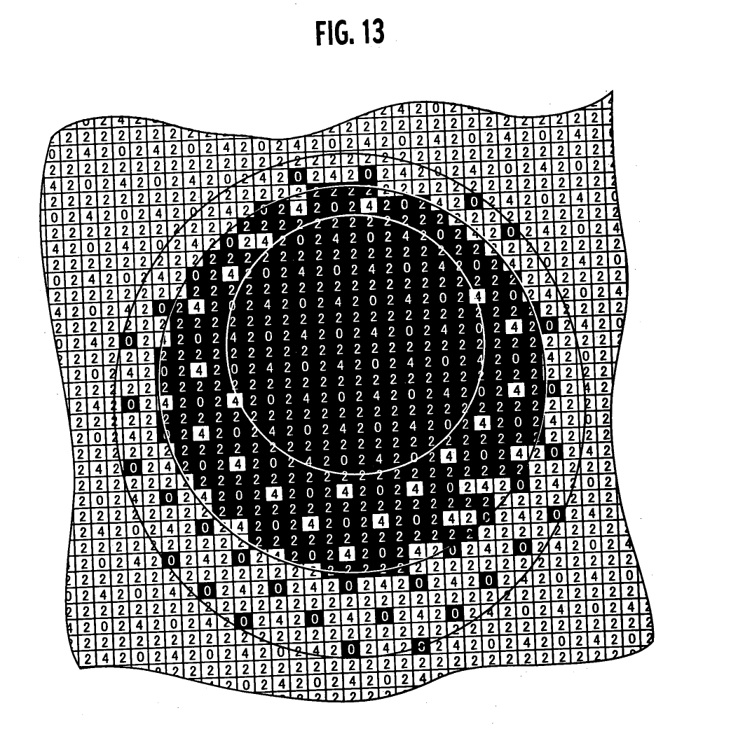

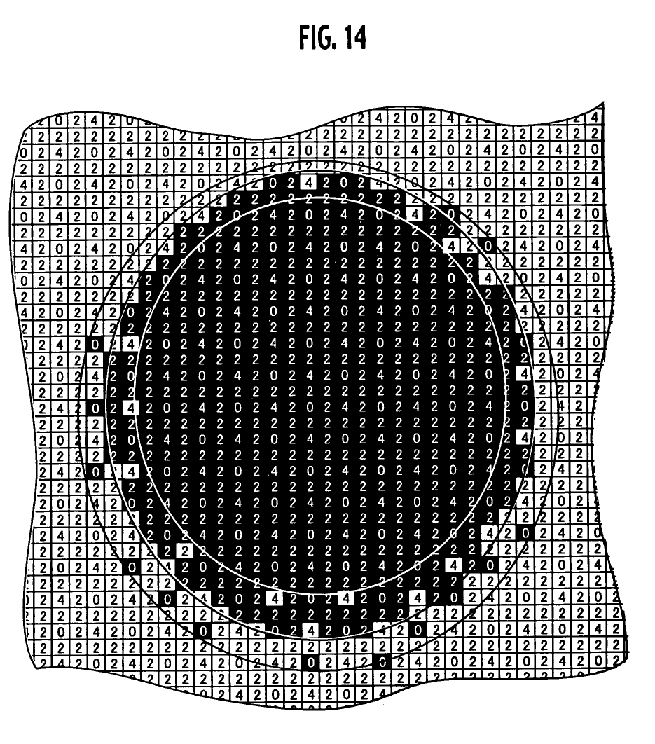

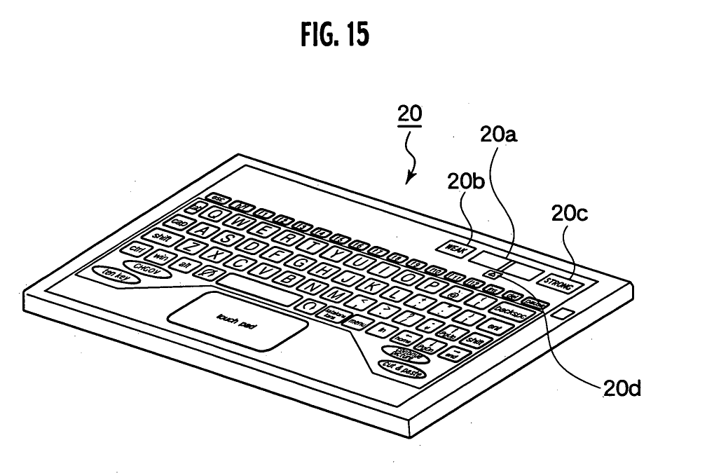

The border determining method mentioned above is applicable to the cases shown in FIG. 10, FIG. 11, FIG. 13 and FIG. 14.

FIG. 13 shows that much stronger pressure than that shown in FIG. 11 is applied. In this case, an innermost oval appears inside the inner oval. In the second inner oval, the contact detectors shown by “0”, “2” and “4” are detected to be pressed, i.e., the contact detectors 210b, 210c and 210d shown in FIG. 8B are pressed.

Referring to FIG. 14, the sizes of the inner oval and innermost oval are enlarged. This means that pressure which is further larger than that of FIG. 13 is applied.

It is possible to reliably detect whether the user intentionally or unintentionally depresses a key or keys by detecting time dependent variations of the sizes of the ovals and time-dependent variations of a size ratios of the ovals, as shown in FIG. 10, FIG. 11, FIG. 13 and FIG. 14.

For instance, the sensor converting the pressure into the electric signal is used to detect the contact pressure of the object onto the contact detecting surface 10a or contact strength on the basis of time-dependent variations of the contact pressure. If the ordinates in FIG. 6 and FIG. 7 are changed to “contact pressure”, the same results will be obtained with respect to “simply placing the object” and “key hitting”.

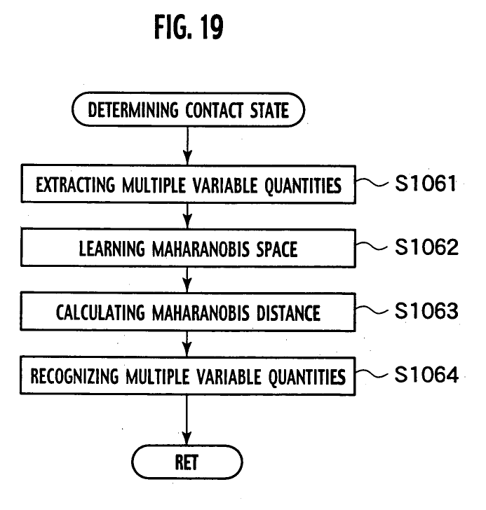

The device control IC 23 (as a determining section) receives the contact strength detected by the contact detecting unit 21, extracts a feature quantity related to the contact strength, compares the extracted feature quantity or a value calculated based on the extracted feature quantity with a predetermined threshold, and determines a contact state of the object. The contact state may be classified into “non-contact”, “contact” or “key hitting”. “Non-contact” represents that nothing is in contact with an image on the display unit 5; “contact” represents that the object is in contact with the image on the display unit 5; and “key hitting” represents that the image on the display unit 5 is hit by the object. Determination of the contact state will be described later in detail with reference to FIG. 18 and FIG. 19.

The thresholds used to determine the contact state are adjustable. For instance, the device control IC23 indicates a key 20b (WEAK), a key 20c (STRONG), and a level meter 20a, which shows levels of the thresholds. Refer to FIG. 15. It is assumed here that the level meter 20a has set certain thresholds for the states “contact” and “key hitting” beforehand. If the user gently hits an image, such key-hitting is often not recognized. In such a case, the “WEAK” button 20b is pressed. The device control IC 23 determines whether or not the “WEAK” button 20b is pressed, on the basis of the position of the button 20b on the display panel 5, and the contact position detected by the contact detecting unit 21. When the button 20b is recognized to be pressed, the display driver 22 is actuated in order to move a value indicated on the level meter 20a to the left, thereby lowering the threshold. In this state, the image is not actually pushed down, but pressure is simply applied onto the image. For the sake of simplicity, the term “key hitting” denotes that the user intentionally pushes down the image. Alternatively, the indication on the level meter 20a may be changed by dragging a slider 20d near the level meter 20a.

The device control IC 23 (as a notifying section) informs the motherboard 30a (shown in FIG. 5) of the operated keyboard or mouse as the input device and the contact state received from the contact detecting unit 21. In short, the position of the key pressed in order to input information, or the position of the key on which the object is simply placed is informed to the motherboard 30a.

The device control IC 23 (as a feature quantity extractor) extracts a feature quantity related to the contact strength of the object on the basis of the contact state detected by the contact detecting unit 21. The feature quantity represents the contact strength of the object, a variation of the contact strength, a length of contact period, a contact position, and so on.

Further, the device control IC 23 (as a special process executing unit) compares the extracted feature quantity with a predetermined threshold, and executes a special process. The predetermined threshold relates to the contact strength or the like which may adversely affect the contact detecting layer 10a.

For instance, the device control IC 23 authenticates the object (i.e., the user) by comparing the feature quantity with the predetermined threshold. If the feature quantity is above the predetermined threshold (which may adversely affect the contact detecting layer 10a), the device control IC 23 issues a warning, or makes the input device 20 inoperative. Further, if the feature quantity is above the predetermined threshold which may corresponds to contact strength at which an unnecessary burden is applied to the object, the device control IC 23 issue a verbal notification or a beep sound for notice via a speaker 26. A warning may be indicated on the display unit, or the input device 20 will be made inoperative. Still further, the device control IC 23 changes modes of the characters on the virtual keyboard of the display unit 5 depending upon whenever or not the feature quantity exceeds the predetermined threshold. For instance, small letters will be changed to capital letters, and vice versa.

The device control IC 23 (as a display controller) shown in FIG. 4 changes the indication mode of the image on the display unit 5 in accordance with the contact state (“non-contact”, “contact” or “key hitting”) of the object on the contact detecting layer 10a. Specifically, the device control IC 23 changes brightness, colors profiles, patterns and thickness of profile lines, blinking/steady lighting, blinking intervals of images in accordance with the contact state.

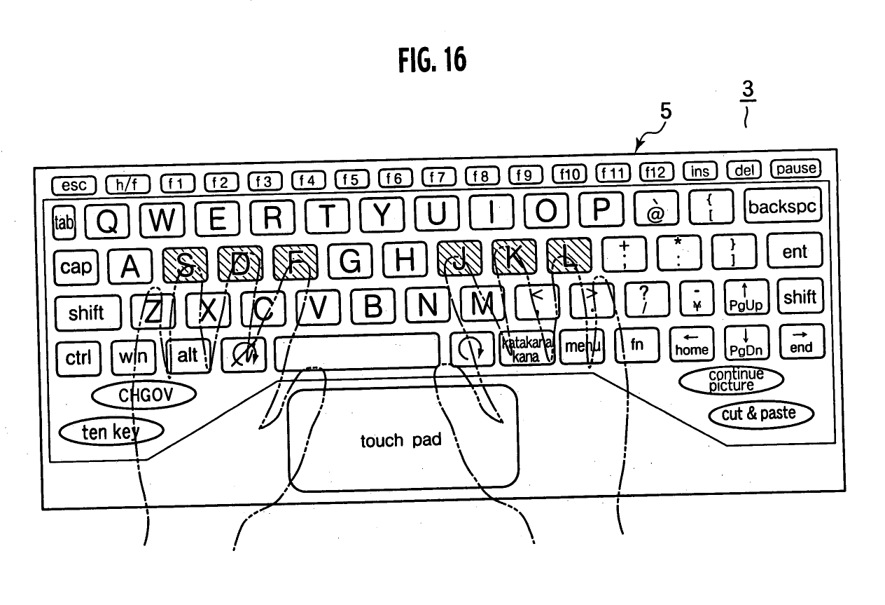

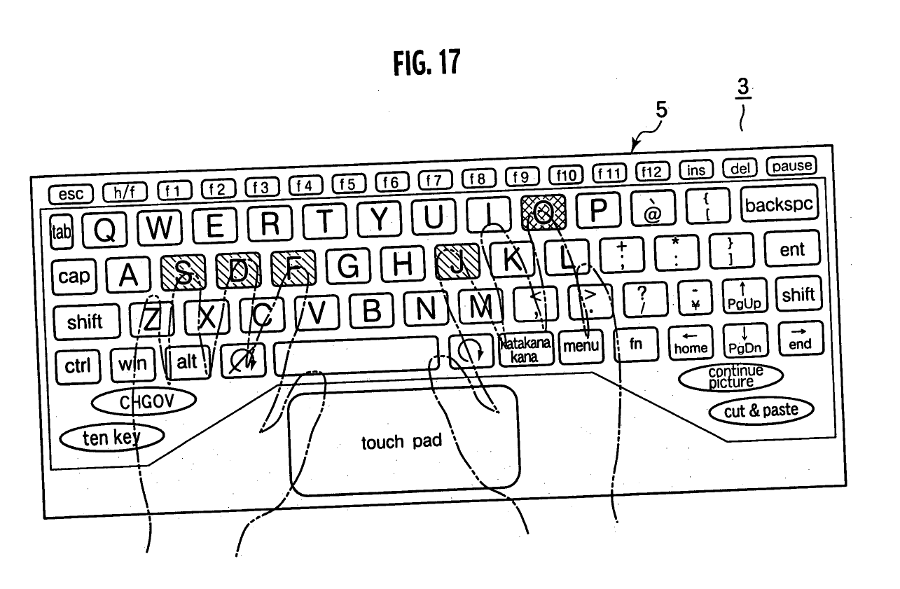

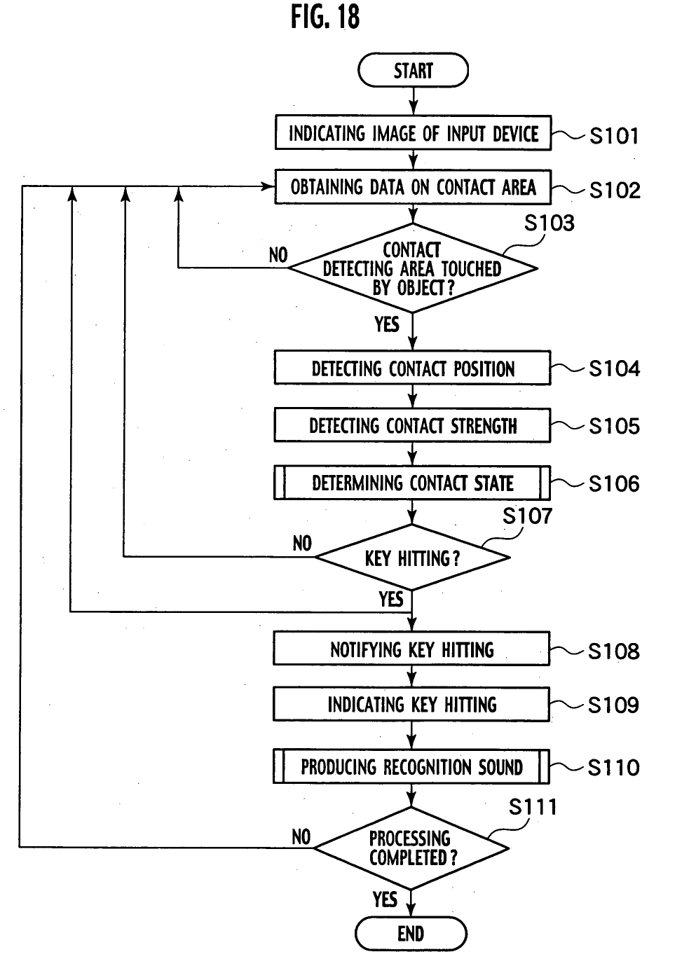

It is assumed here that the display unit 5 indicates the virtual keyboard 5a, and the user is going to input information. Refer to FIG. 16. The user places his or her fingers at the home positions in order to start to key hitting. In this state, the user's fingers are on the keys “S”, “D”, “F”, “J”, “K” and “L”. The device control IC 23 lights the foregoing keys in yellow, for example. The device control IC lights the remaining non-contact keys in blue, for example. In FIG. 17, when the user hits the key “O”, the device control IC 23 lights the key “O” in red, for example. The keys “S”, “D”, “F” and “J” remain yellow, which means that the user's fingers are on these keys.

If it is not always necessary to identify “non-contact”, “contact” and “key hitting”, the user may select the contact state in order to change the indication mode.

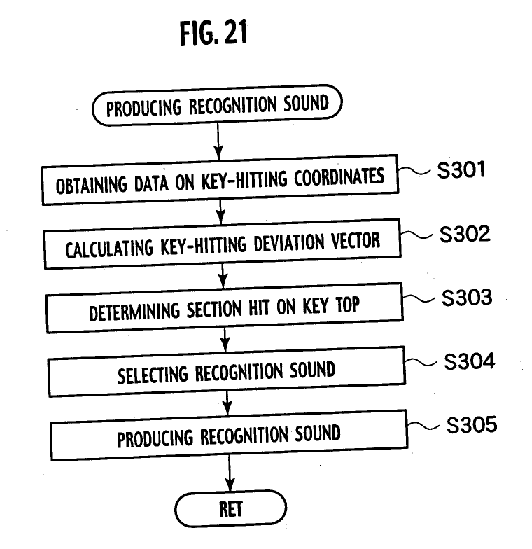

Further, the device control IC 23 functions as a sound producing section, decides a predetermined recognition sound in accordance with the contact state on the basis of the relationship between the position detected by the contact detecting section 21 and the position of the image of the virtual keyboard or mouse, controls the speaker driver 25, and issues the recognition sound via the speaker 26. For instance, it is assumed that the virtual keyboard 5a is indicated on the display unit 5, and that the user may hit a key. In this state, the device control IC 23 calculates a relative position of the key detected by the contact detecting unit 21 and the center of the key indicated on the display unit 5. This calculation will be described in detail later with reference to FIG. 21 to FIG. 23.

When key hitting is conducted and a relative distance between an indicated position of a hit key and the center thereof is found to be larger than a predetermined value, the device control IC 23 actuates the speaker driver 25, thereby producing a notifying sound. The notifying sound may have a tone, time interval, pattern or the like different from the recognition sound issued for the ordinary “key hitting”.

It is assumed here that the user enters information using the virtual keyboard on the display unit 5. The user puts the home position on record beforehand. If the user places his or her fingers on keys other than the home position keys, the device control IC 23 recognizes that the keys other than the home position keys are in contact with the user's fingers, and may issue another notifying sound different from that issued when the user touches the home position keys (e.g. a tone, time interval or pattern).

A light emitting unit 27 is disposed in the lower housing 2A, and emits light in accordance with the contact state determined by the device control IC 23. For instance, when it is recognized that the user places his or her fingers on the home position keys, the device control IC 23 makes the light emitting unit 27 luminiferous.

The memory 24 stores histories of contact positions and contact strength of the object for a predetermined time period. The memory 24 may be a random access memory (RAM), a nonvolatile memory such as a flash memory, a magnetic disc such as a hard disc or a flexible disc, an optical disc such as a compact disc, an IC chip, a cassette tape, and so on.

The following describe how to store various information processing programs. The input device 20 stores in the memory 24 information processing programs, which enable the contact position detecting unit 21 and device control IC 23 to detect contact positions and contact strength, to determine contact states, and to execute special process_(to be described later). The input device 20 includes an information reader (not shown) in order to store the foregoing programs in the memory 24. The information reader obtains information from a magnetic disc such as a flexible disc, an optical disc, an IC chip, or a recording medium such as a cassette tape, or downloads programs from a network. When the recording medium is used, the programs may be stored, carried or sold with ease.

The input information is processed by the device control IC 23 and so on which execute the programs stored in the memory 24. Refer to FIG. 18 to FIG. 23. Information processing steps are executed according to the information processing programs.

It is assumed that the user inputs information using the virtual keyboard shown on the display unit 5 of the input unit 3.

The information is processed in the steps shown in FIG. 18. In step S101, the input device 20 shows the image of an input device (i.e., the virtual keyboard) on the display unit 5. In step S102, the input device 20 receives data of the detection areas on the contact detecting layer 10a of the touch panel 10, and determines whether or not there is a detection area in contact with an object such as a user's finger. When there is no area in contact with the object, the input device 20 returns to step S102. Otherwise, the input device 20 advances to step S104.

The input device 20 detects the position where the object is in contact with the contact detecting layer 10a in step S104, and detects contact strength in step S105.

In step S106, the input device 20 extracts a feature quantity corresponding to the detected contact strength, compares the extracted feature quantity or a value calculated using the feature quantity with a predetermined threshold, and identifies a contact state of the object on the virtual keyboard. The contact state is classified into “non-contact”, “contact” or “key hitting” as described above. FIG. 7 shows the “key hitting”, i.e., the contact area A is substantially zero at first, but abruptly increases. This state is recognized as the “key hitting”. Specifically, a size of the contact area is extracted as the feature quantity as shown in FIG. 6 and FIG. 7. An area velocity or an area acceleration is derived using the size of the contact area, i.e., a feature quantity ΔA/Δt or Δ²A/Δt² is calculated. When this feature quantity is above the threshold, the contact state is determined to be the “key hitting”.

The threshold for the feature quantity ΔA/Δt or Δ²A/Δt² depends upon a user or an application program in use, or may gradually vary with time even if the same user repeatedly operates the input unit. Instead of using a predetermined and fixed threshold, the threshold will be learned and re-calibrated at proper timings in order to improve accurate recognition of the contact state.

In step S107, the input device 20 determines whether or not the key hitting is conducted. If not, the input device 20 returns to step S102, and obtains the data of the detection area. In the case of the “key hitting”, the input device 20 advances to step S108, and notifies the computer main unit 30 of the “key hitting”. In this state, the input device 20 also returns to step S102 and obtains the data of the detection area for the succeeding contact state detection. The foregoing processes are executed in parallel.

In step S109, the input device 20 changes the indication mode on the virtual keyboard in order to indicate the “key hitting”, e.g., changes the brightness, color, shape, pattern or thickness of the profile line of the hit key, or blinking/steady lighting of the key, or blinking/steady lighting interval. Further, the input device 20 checks lapse of a predetermined time period. If not, the input device 20 maintains the current indication mode. Otherwise, the input device 20 returns the indication mode of the virtual keyboard to the normal state. Alternatively, the input device 20 may judge whether or not the hit key blinks the predetermined number of times.

In step S110, the input device 20 issues a recognition_sound (i.e., an alarm). This will be described later in detail with reference to FIG. 21.

FIG. 19 shows the process of the “key hitting” in step S106.

First of all, in step S1061, the input device 20 extracts multivariate data (feature quantities). For instance, the following are extracted on the basis of the graph shown in FIG. 7: a maximum size Aₘₐₓ of the contact area, a transient size S_{A} of the contact area A derived by integrating a contact area A, a time T_{P} until the maximum size of the contact area, and a total period of time Tₑ of the key hitting from the beginning to end. A rising gradient k=Aₘₐₓ/T_{P} and so on are calculated on the basis of the foregoing feature quantities.

The foregoing qualitative and physical characteristics of the feature quantities show the following tendencies. The thicker the user's fingers and stronger the key hitting, the larger the maximum size Aₘₐₓ of the contact area. The stronger the key hitting, the larger the transient size S_{A} of the contact area A. The more soft the user's fingers and the stronger and slower the key hitting, the longer the time until the maximum size of the contact area T_{P}. The slower the key hitting and the more soft the user's fingers, the longer the total period of time Tₑ. Further, the quicker and stronger the key hitting and the harder the user's fingers, the larger the rising gradient k=Aₘₐₓ/T_{P}.

The feature quantities are derived by averaging values of a plurality of key-hitting times of respective users, and are used for recognizing the key hitting. Data on only the identified key hitting are accumulated, and analyzed. Thereafter, thresholds are set in order to identifying the key hitting. In this case, the key hitting canceled by the user are counted out.

The feature quantities may be measured for all of the keys. Sometimes, the accuracy of recognizing the key hitting may be improved by measuring the feature quantities for every finger, every key, or every group of keys.

Separate thresholds may be determined for the foregoing variable quantities. The key hitting may be identified on the basis of a conditional branch, e.g., when one or more variable quantities exceed the predetermined thresholds. Alternatively, the key hitting may be recognized using a more sophisticated technique such as the multivariate analysis technique.

For example, a plurality of key-hitting times are recorded. Mahalanobis spaces are learned on the basis of specified sets of mutivariate data. A Mahalanobis distance of the key hitting is calculated using the Mahalanobis spaces. The shorter the Mahalanobis distance, the more accurately the key hitting is identified. Refer to “The Mahalanobis-Taguchi System”, ISBN:0-07-136263-0, McGraw-Hill, and so on.

Specifically, in step S1062 shown in FIG. 19, an average and a standard deviation are calculated for each variable quantity in multivariate data. Original data are subject to z-transformation using the average and standard deviation (this process is called “standardization”). Then, correlation coefficients between the variable quantities are calculated to derive a correlation matrix. Sometimes, this learning process is executed only once when initial key hitting data are collected, and is not updated. However, if a user's key hitting habit is changed, if the input device is mechanically or electrically aged, or if the recognition accuracy of the key hitting lowers for some reason, relearning will be executed in order to improve the recognition accuracy. When a plurality of users login, the recognition accuracy may be improved for each user.

In step S1063, the Mahalanobis distance of key hitting data to be recognized is calculated using the average, standard deviation and a set of the correlation matrix.

The mulivariate data (feature quantities) are recognized in step S1064. For instance, when the Mahalanobis distance is smaller than the predetermined threshold, the object is recognized to be in “the key hitting” state.

When the algorithm in which the shorter the Mahalanobis distance, the more reliably the key hitting may be recognized is utilized, the user identification can be further improved compared with the case where the feature quantities are used as they are for the user identification. This is because when the Mahalanobis distance is utilized, the recognition, i.e., pattern recognition, is conducted taking the correlation between the learned variable quantities into consideration. Even if the peak value Aₘₐₓ is substantially approximate to the average of the key hitting data but the time T_{P} until the maximum size of the contact area is long, a contact state other than the key hitting will be accurately recognized.

In this embodiment, the key hitting is recognized on the basis of the algorithm in which the Mahalanobis space is utilized. It is needless to say that a number of variable quantities may be recognized using other multivariate analysis algorithms.

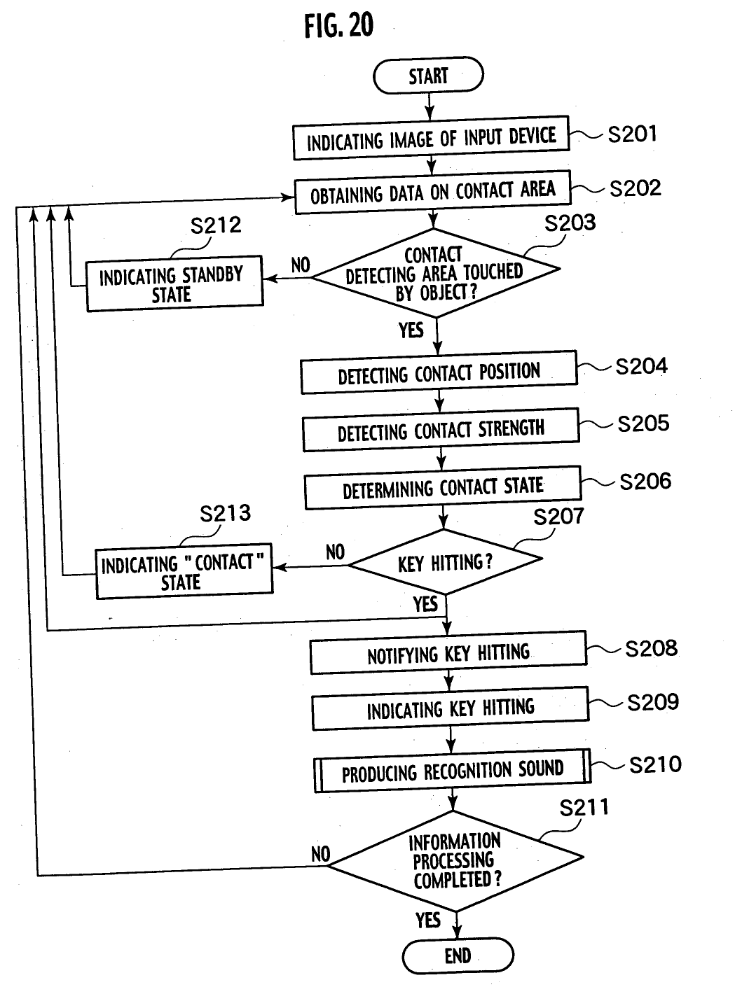

The following describe a process to change indication modes for indicating the “non-contact” and “contact” states with reference to FIG. 20.

Steps S201 and S202 are the same as steps S101 and S102 shown in FIG. 18, and will not be referred to.

In step 203, the input device 20 determines whether or not the contact detecting layer 10a is touched by the object. If not, the input device 20 advances to step S212. Otherwise, the input device 20 goes to step S204.

In step S212, the input device 20 recognizes that the keys are in the “non-contact” state on the virtual keyboard, and changes the key indication mode (to indicate a “standby state”). Specifically, the non-contact state is indicated by changing the brightness, color, shape, pattern or thickness of a profile line which is different from those of the “contact” or “key hitting” state. The input device 20 returns to step S202, and obtains data on the detection area.

Steps S204 to S206 are the same as steps S104 to S106, and will not be described here.

The input device 20 advances to step S213 when no key hitting is recognized in step S207. In step S213, the input device 20 recognizes that the object is in contact with a key on the virtual keyboard, and changes the indication mode to an indication mode for the “contact” state. The input device 20 returns to step S202, and obtains data on the detected area. When the key hitting is recognized, the input device 20 advances to step S208, and then returns to step S202 in order to recognize a succeeding state, and receives data on a detection area.

Steps S208 to S211 are the same as steps S108 to S111, and will not be described here.

In step S110 (shown in FIG. 18), the alarm is produced if the position of the actually hit key differs from an image indicated on the input device (i.e., the virtual keyboard).

Refer to FIG. 21, in step S301, the input device 20 acquires a key hitting standard coordinate (e.g., barycenter coordinate which is approximated based on a coordinate group of the contact detector 10b of the hit key).

Next, in step S302, the input device 20 compares the key hitting standard coordinate and the standard coordinate (e.g., a central coordinate) of the key hit on the virtual keyboard. The following is calculated; a deviation between the key hitting standard coordinate and the standard coordinate (called the “key-hitting deviation vector”), i.e., the direction and length on x and y planes extending between the key hitting standard coordinate and the standard coordinate of the hit key.

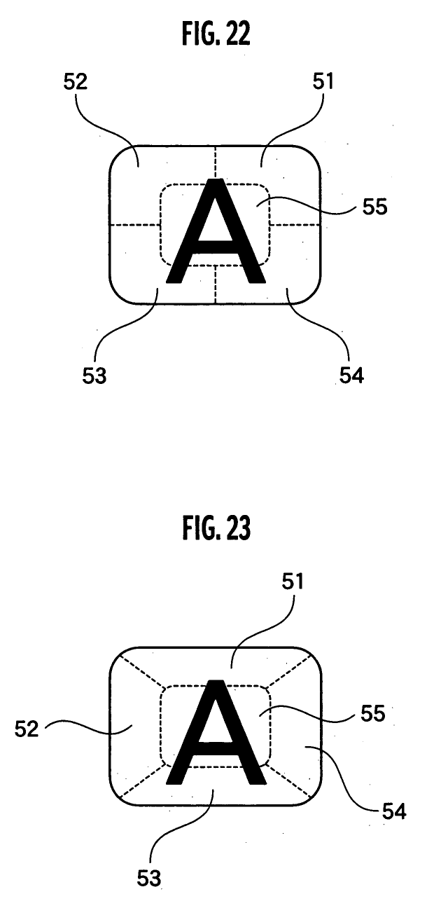

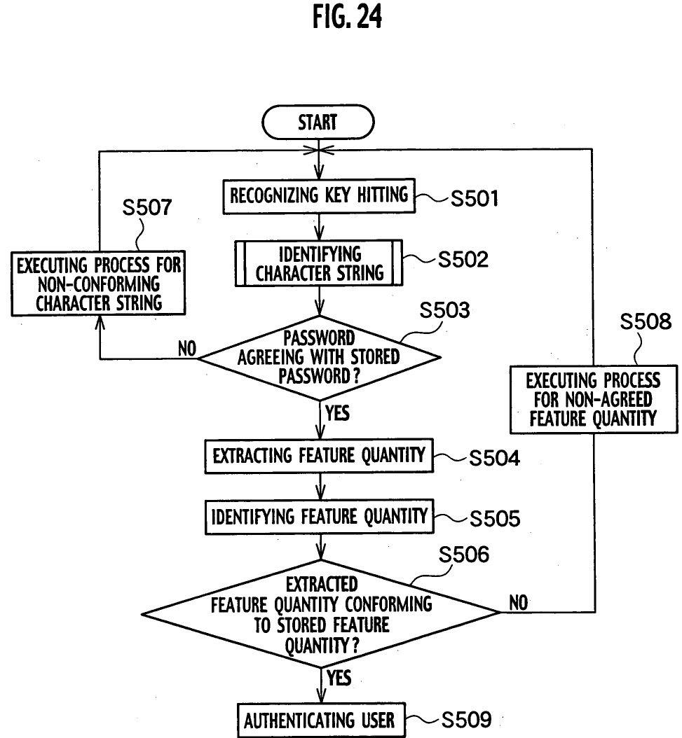

In step S303, the input device 20 identifies at which section the coordinate of the hit key is present on each key top on the virtual keyboard. The key top may be divided into two, or into five sections as shown in FIG. 22 and FIG. 23. The user may determine the sections on the key top. The sections 55 shown in FIG. 22 and FIG. 23 are where the key is hit accurately.

The input device 20 determines a recognition sound on the basis of the recognized section. Recognition sounds having different tones, time intervals or patterns are used for the sections 51 to 55 shown in FIG. 22 and FIG. 23.

Alternatively, the input device 20 may change the recognition sounds on the basis of the length of the key-hitting deviation vector. For instance, the longer the key hitting deviation vector, the higher pitch the recognition sound has. The intervals or tones may be changed in accordance with the direction of the key hitting deviation vector.

If the user touches across two sections of one key top, an intermediate sound may be produced in order to represent two sections. Alternatively, the intermediate sound may be produced depending upon respective sizes of contacted sections. A sound may be produced for a larger section.

In step S305, the input device 20 produces the selected recognition sound at a predetermined volume. The input device 20 checks the elapse of a predetermined time period. If not, the recognition sound will be continuously produced. Otherwise, the input device 20 stops the recognition sound.

With respect to step S304, the different recognition sounds are provided for the sections 51 to 55. Alternatively, the recognition sound for the section 55 may be different from the recognition sounds for the sections 51 to 54. For instance, when the section 55 is hit, the input device 20 recognizes the proper key hitting, and produces the recognition sound which is different from the recognition sounds for the other sections. Alternatively, no sound will be produced in this case.

The user may determine a size or shape of the section 55 as desired depending upon its percentage or a ratio on a key top. Further, the section 55 may be automatically determined based on a hit ratio, or a distribution of x and y components of the key hitting deviation vector.

Alternatively, a different recognition sound may be produced for the sections 51 to 54 depending upon whether the hit part is in or out of the section 55.

The sections 55 of all of the keys may be independently or simultaneously adjusted, or the keys may be divided into a plurality of groups, each of which will be adjusted individually. For instance, key hitting deviation vectors of the main keys may be accumulated in a lump. Shapes and sizes of such keys may be simultaneously changed.

The input device 20 uses the information processing method and program, and executes the special processes for authenticating users, protecting the devices, protecting users, and selecting character modes. It is assumed there that the user enters information using the virtual keyboard.

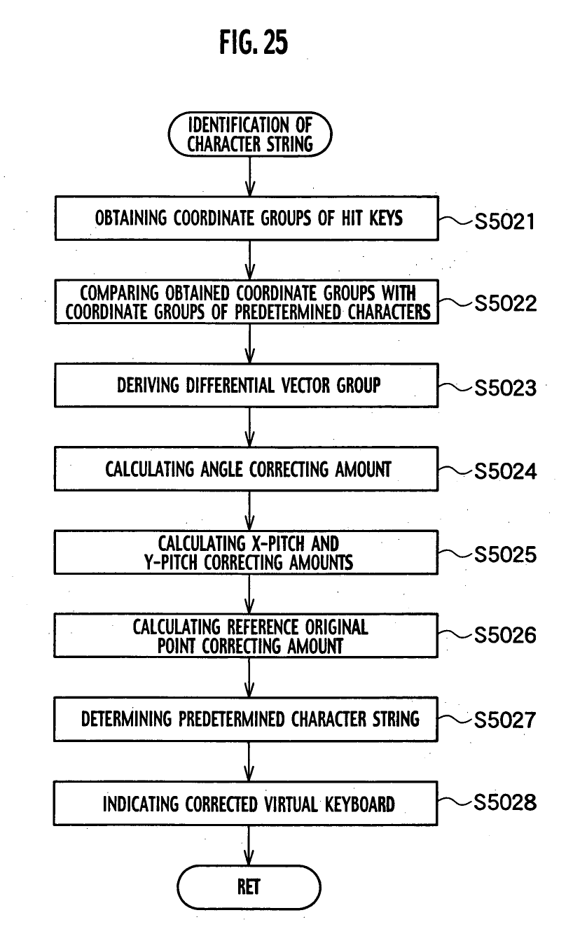

The user authentication is executed when the user hits keys in order to enter a string of particular characters (constituting a “password”). Refer to FIG. 24 and FIG. 25. The user is authenticated only when the user's key-hitting characteristics data (such as a key hitting pressure, variations of sizes of contact areas, or a history of key-hitting time) and character string data agree with predetermined data. The password and the key-hitting characteristics data have been stored in the memory 24 (shown in FIG. 4).

In step S501, the input device 20 recognizes the key hitting on the basis of the entered password.

The input device 20 then identifies the character string in step S502 as will be described later.

In step S503, the input device 20 checks whether or not the entered password agrees with the stored password. When they are identical, the input device 20 advances to step S503. Otherwise, the input device 20 goes to step S507 in order to execute a disagreement process, e.g. the input device 20 is made inoperative.

The input device 20 extracts a feature quantity related to the key-hitting characteristics data (i.e., the key hitting pressure, the variations of the size of the contact area, or the history of key hitting time). The extracted feature quantity is compared with predetermined feature quantity, and is recognized when they are identical.

Average key-hitting pressures tend to vary with respective users, and tend to fluctuate. Further, key-hitting strengths vary with respective keys and users' fingers. These characteristics are analyzed for every user, feature quantities for pinpointing users are stored, and the stored feature quantities are compared with the key-hitting data. Hence, the user authentication is performed.

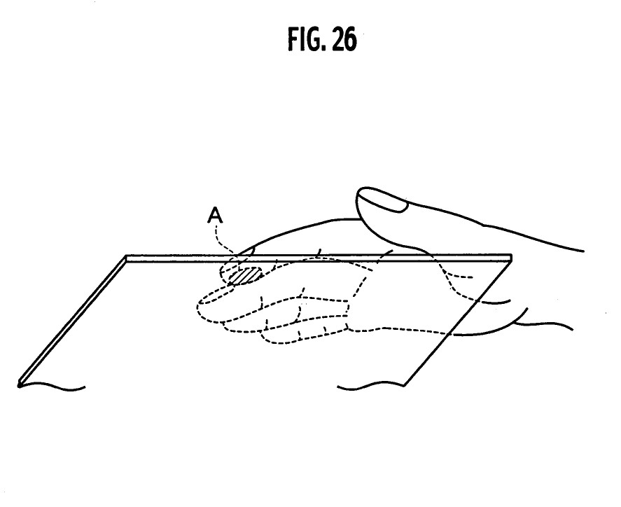

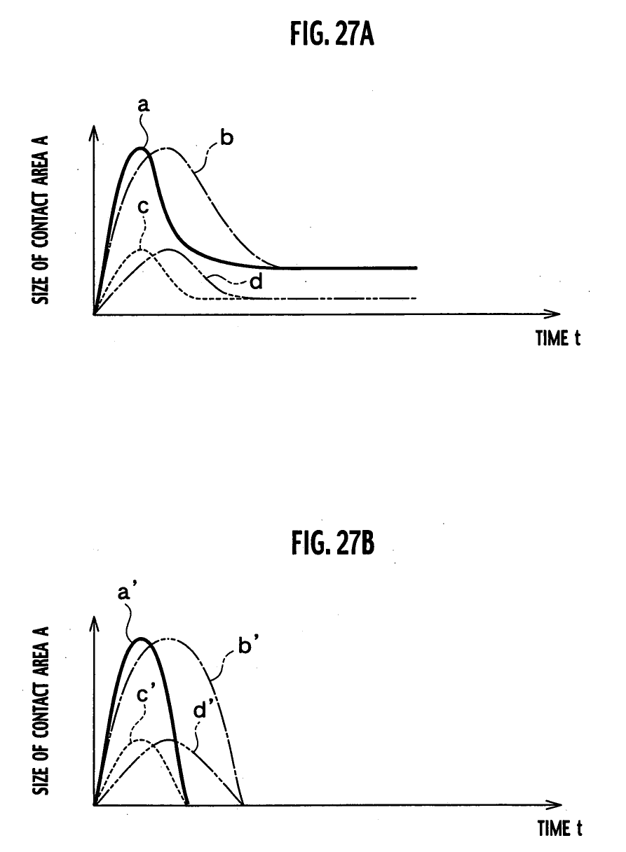

The variation of the size of the contact area depends upon thickness and flexibility of the user's fingers, key-hitting strength, and fingers used for the key hitting. Therefore, sizes of contact areas and histories of time-depending variations of sizes of the contact area also tend to vary. Referring to FIG. 26, the user's finger comes into contact with the key top via an area A (called the “contact area A”). As shown in FIG. 27A, sizes of the contact area A vary when the user's finger remains on the hit key. When the finger gets away from the key immediately after the key hitting, the contact area A changes its size as shown in FIG. 27B. In the latter case, the user lightly hits the key. The key-hitting period depends upon users. Sizes of the contact area A vary differently as shown by curves a, b, c, and d shown in FIG. 27A. In FIG. 27A and FIG. 27B, neither scale nor unit are shown. Actual values may be used when mounting components.

The feature quantities are extracted as described with reference to steps 1061 to 1064 shown in FIG. 19, and will not be described here.

In step S506, the input device 20 checks whether or not the extracted feature quantity agrees with the predetermined feature quantity. When they are identical, the input device 20 advances to step S509. Otherwise, the input device 20 goes to step S508, and stops functioning.

When the user is authenticated in step S509, a starting process will be executed. Alternatively, a power switch will be activated. This measure is effective in assuring the security of the microcomputer, reducing power consumption or preventing breakage of units when the microcomputer is erroneously actuated while it is being carried, and preventing problems caused if the microcomputer is heated in a carrying bag or case, and so on.

Predetermined conditions such as the number of times and periods of authentication errors are stored. When authentication errors are repeatedly detected, they are compared with the stored data. If they conflict with the stored data, the microcomputer may be made inoperative since the password is willfully misused by a third party, or no data may be read.

Step S502 (in FIG. 24) is described in detail with reference to FIG. 25. In step S5021, the input device 20 obtains data on coordinates of the key hit by the user, and compares the obtained coordinates with predetermined coordinates of the character.

In step S5023, a differential vector group representing a difference between the coordinates of the hit key and the predetermined coordinates of the character is derived. The differential vector group includes vectors corresponding to the entered characters (constituting the password). A primary straight line is created using the method of least square on the basis of a start point group composed of only start points of respective differential vectors and only an end-point group composed of end-points of the respective differential vectors.
y=a₁x+b₁
y=a₂x+b₂

In step S5024, a₁ and a₂ are compared. Hence, it is checked how much rotation angles from a reference point in the xy plane when hitting the key. Angular correction amounts are calculated. Otherwise, the characters in the password are divided into groups in which the characters may have the same y coordinate in one line. Hence, angles in the x direction are averaged. The averaged angle is utilized as the angular correction amount as it is when the password characters are in one line.

Next, in step S 5025, a keyboard standard position of the start point groups are compared with a keyboard standard position which is estimated on the basis of the end-point groups, thereby calculating an amount for correcting the x pitch and y pitch. A variety of methods are conceivable for this calculation. For instance, a median point of the coordinates of the start point groups and a median point of the coordinates of the end-point groups may be simply compared, thereby deriving a difference between the x direction and the y direction.

In step S5026, a pace of expansion (kx) in the x direction and a pace of expansion (ky) in the y direction are separately adjusted in order to minimize an error between x coordinates and y coordinates of the start point group and end-point group. Further, an amount for correcting the standard original point may be derived explanatorily (using a numerical calculation method) in order to minimize a squared sum of the error, or arithmetically using the method of least square.

In step S5027, the input device 20 authenticates the character string of the password, i.e. determines whether or not the entered password agrees with the password stored beforehand.

In step S5028, the input device 20 indicates a corrected input range (i.e., the virtual keyboard 25) on the basis of the angle correction amount, x-pitch and y-pitch correction amounts, and standard original point correction amount which have been calculated in steps S5024 to S5026.

The calculations in steps S5024, S5025 and S2056, respectively, are conducted in order to apply suitable transformation T to the current keyboard layout, so that a preferable keyboard layout will be offered to the user. The current keyboard layout may be the same that has been offered when shipping the microcomputer, or that was corrected in the past.

Alternatively, the transformation T may be derived as follows. First of all, the user is requested to hit a character string S composed of N characters. A set U of N two-dimensional coordinates (which deviate from the coordinates of the center of the key top) on the touch panel is compared to the coordinates C of the center of the key tops of the keys for the character string S. The transformation T will be determined in order to minimize a difference between the foregoing coordinates as will described hereinafter. Any method will be utilized for this calculation. The two-dimensional coordinates or two-dimensional vectors are denoted by [x, y].

The set U composed of N two-dimensional coordinates is expressed as [xi, yi] (i=1, 2, . . . , N). A center coordinate C′ after the transformation T is expressed as [ξi, ηi] (i=1, 2, . . . , N). The transformation T is accomplished by parallel displacement, rotation, expansion or contraction of the coordinate group as a whole. [e, f] denotes a vector representing the parallel displacement. θ denotes a rotation angle. λ denotes an magnification/contraction coefficient. [e, f]=[c−a, d−b] may be calculated on the basis of the center point [a, b] of the current keyboard layout as a whole, and an average coordinate of U [c, d]=[(x1+x2 . . . +xN)/N, (y1+y2 . . . +yN)/N]. When the current keyboard layout is transformed in accordance with the rotation angle θ and expansion/contraction coefficient λ, the transformed coordinates will be [ξi, ηi]=[λ{(Xi−e) cos θ−(Yi−f) sin θ}, λ{(Xi−e) sin θ+(Yi−f) cos θ}], (i=1, 2 . . . , N). It is assumed there that initial entries of θ and λ are set to be 0 and 1, respectively. The parameters θ and λ (which minimize a sum Δ1+Δ2+ . . . , ΔN of a squared distance Δi=(ξi−xi)ˆ2+(ηi−yi)ˆ2) are numerically derived using a Sequential Quadratic Programming (SQP) method. The transformed coordinate set [ξi, ηi](i=1; 2, . . . , N) derived by applying the calculated θ and λ denotes a new keyboard layout. When the transformed coordinate set C′, has a large margin of error due to mistyping or the like, θ and λ may not become converged. In such a case, no authentication of the letter strings is carried out, and the keyboard layout should not be adjusted. Therefore, the user is again requested to hit the keys for the letter string S.

Alternatively, sometimes more preferable results may be accomplished when λ is adjusted respectively in the x and y directions, so that the traverse pitch and the vertical pitch can be optimized.

Further, when the transformation T is appropriately devised, the keyboard layout may be adjusted on a keyboard on which keys are arranged in a curved state, a keyboard on which a group of keys hit by the left hand and a group of keys hit by the right hand are arranged at separated places.

The foregoing layout adjustment may be applied separately to the keys hit by the left and right hands. The forgoing algorithm may be applied in order to anomalistically arrange the left-hand and right-hand keys in a fan shape as in some computers on the market.

The foregoing correction is used only at the time of authentication. The corrected key layout will not be indicated on the display unit, or a partially corrected or modified keyboard layout may be indicated only when the pitch adjustment is conducted. When the keys are arranged deviating from the edge of the lower housing, or when they are arranged asymmetrically, the use may feel uncomfortable with the keyboard. In such a case, the rotation angle will not be arranged or the keys will be arranged symmetrically.

The keyboard layout will be improved with respect to its convenience and appearance by applying a variety of geometrical restrictions as described above.

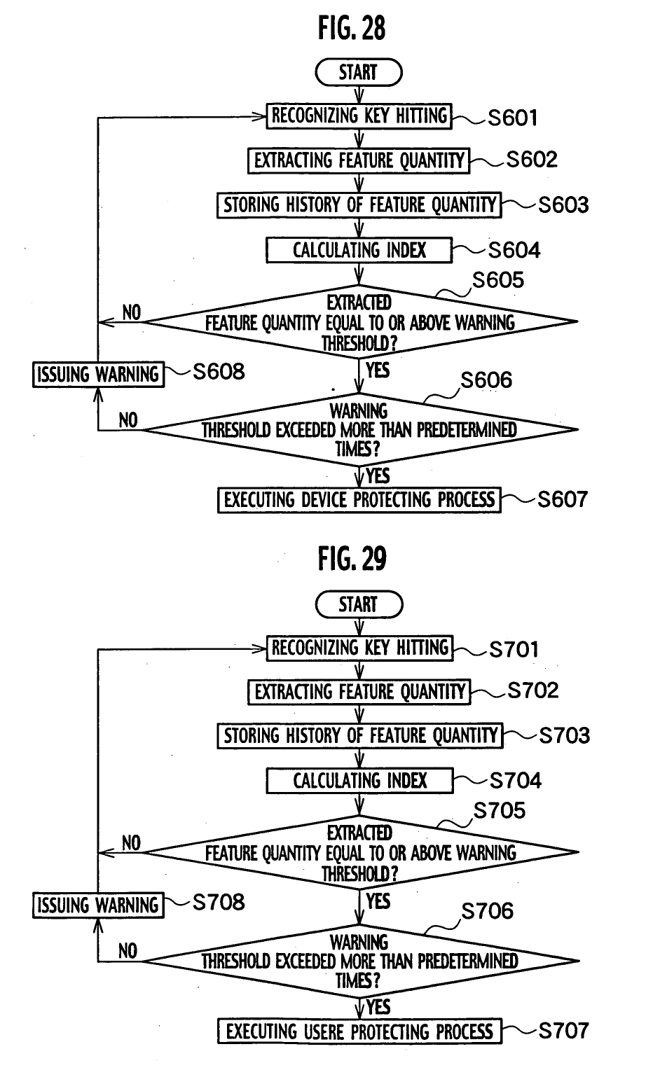

Referring to FIG. 28, contact strength of the object contacted to the touch panel is detected, and an warning is issued or the input device 20 is made inoperative when the contact strength may adversely affect the touch panel. An index at which the contact strength affects the touch panel is calculated on the basis of the history of contact strength or contact positions stored in the memory 24. When the index is above a predetermined threshold, the warning will be issued, or the input device 20 is made inoperative.

In step S601, the input device 20 recognizes that the user hits keys on the virtual keyboard 25.

In step S602, the input device 20 extracts feature quantities related to the contact strength. For instance, the following are extracted on the basis of the graph shown in FIG. 7: the maximum size Aₘₐₓ of the contact area, the transient size S_{A} of the contact area A, the time until the maximum size of the contact area T_{P} to accomplish the maximum size Aₘₐₓ of the contact area, and the total period of time Tₑ, the rising gradient k, the number of times of key hitting, length of the microcomputer in operation, and so on. In step S603, the input device 20 stores the histories of the feature quantities in the memory 24.

In step S604, the input device 20 calculates the index using one or plurality of the feature quantities, i.e., the maximum size Aₘₐₓ of the contact area A, the transient size S_{A} of the contact area A, the maximum time T_{P} to accomplish the maximum size Aₘₐₓ of the contact area A, and the total period of time Tₑ, the rising gradient k, the number of times of key hitting, length of the microcomputer in operation, and so on. The index may depend upon the maximum values of the foregoing feature quantities, or may be determined on the basis of physical characteristics of the microcomputer. A warning threshold is set for the calculated index, and is a minimum value at which the touch panel may be damaged.

In step S605, the input device 20 checks whether or not the feature quantities are above the warning threshold. If not, the input device 20 returns to step S601. Otherwise, the input device 20 advances to step S606.

In step S606, the input device 20 checks whether or not the index exceeds the warning threshold the predetermined number of times. If not, the input device 20 advances to step S608. Otherwise, the input device 20 goes to step S607.

In step S608, the input device 20 issues a warning, e.g., a message such as “Your key touch is too strong. Please hit keys softly to protect the input device.” will be indicated on the display unit of the microcomputer.

In step S607, the input device 20 conducts a device protecting process. For instance, the display unit shows another message “Your key touch is too strong. A key-hitting limiter will be actuated since the microcomputer may be damaged.” Then, no information will be entered for a predetermined period of time, for instance.

In the case of the warning, the user can keep on hitting keys. On the other hand, during the microcomputer protecting process, the input device 20 is forcibly suspended. This is effective in urging the user to hit keys softly.

FIG. 29 shows a process which is executed to extract strength by which the user hits keys on the touch panel. If the contact strength may apply an unnecessary burden to the user, a warning will be issued, or the input device 20 will be made inoperative. Specifically, an index of the contact strength which may cause the unnecessary burden on the user is calculated on the basis of histories of contact strength and contact positions stored in the memory 24.

In step S701, the input device 20 recognizes that the user hit keys on the virtual keyboard.

In step S702, the input device 20 calculates the index using the feature quantities related to the contact strength, i.e., the maximum size Aₘₐₓ of the contact area, the transient size S_{A} of the contact area A, the maximum time T_{P} to accomplish the maximum size Aₘₐₓ of the contact area, and the total period of time Tₑ, the rising gradient k, the number of times of key hitting, length of the microcomputer in operation, and so on. In step S703, the input device 20 stores the histories of the feature quantities in the memory 5.

In step S704, the input device 20 calculates the index using the feature quantities related to the contact strength, i.e., the maximum size Aₘₐₓ of the contact area, the transient size S_{A} of the contact area A, the maximum time T_{P} to accomplish the maximum size Aₘₐₓ of the contact area, and the total period of time Tₑ, the rising gradient k, the number of times of key hitting, length of the microcomputer in operation, and so on. The index may depend upon the maximum values of the foregoing feature quantities, or may be determined on the basis of physical characteristics of the microcomputer. A warning threshold is set for the calculated index, and is a minimum value at which the contact strength may cause the unnecessary burden on the user.

In step S705, the input device 20 checks whether or not the feature quantities become larger than the warning threshold. If not, the input device 20 returns to step S701. Otherwise, the input device 20 advances to step S706.

In step S706, the input device 20 checks whether or not the index exceeds the warning threshold the predetermined number of times. If not, the input device 20 advances to step S708. Otherwise, the input device 20 goes to step S707.

The input device 20 issues a warning in step S708. For instance, a message “Your key touch is too strong. Please hit keys softly or unnecessary burdens are applied to you.” will be indicated.

In step S707, the input device 20 executes the user protecting process. For instance, a message such as “Your key touch is too strong. A key-hitting limiter will be actuated.” will be indicated. Thereafter, the input device 20 will be made inoperative for a certain period of time when excessively strong key-hitting is recognized.

In the case of the warning, the user can keep on hitting keys. On the other hand, during the user protecting process, the input device 20 is forcibly interrupted. This is effective in urging the user to hit keys softly.

In the foregoing description, it is assumed that the user hits keys using his or her fingers as the object. Further, the object such as an input pen will be also protected by executing the warning process.

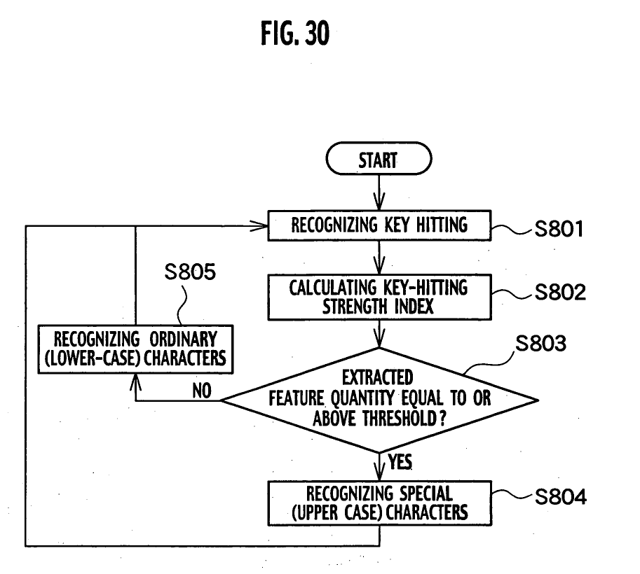

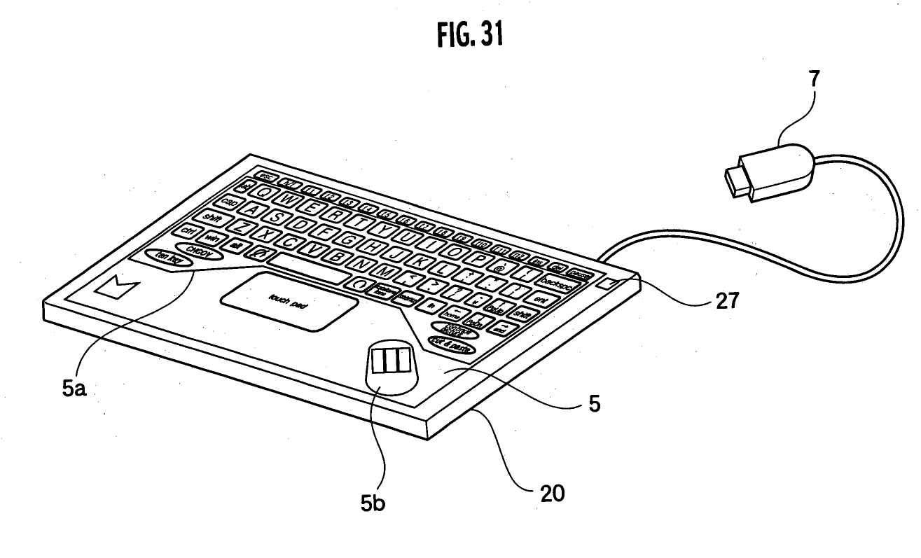

Characters are shifted from upper case to lower case and vice versa depending upon the contact strength in a process shown in FIG. 30. To capitalize a first character, the user is required only to hit the key strongly. The input device 20 capitalizes the key for the first character in accordance with the contact strength. Usually, a special key such as “Crtl” key is also hit on the keyboard, or a mode of an input/word conversion program, a so-called front end processor, is changed for this purpose. Specifically, the user strongly hits keys which should be capitalized, and hits other keys with the normal strength.

In step S801, the input device 20 recognizes that the user hits keys on the virtual keyboard 25, and extracts the feature quantities as described with reference to steps S602 and S603 shown in FIG. 28.

In step S802, the input device 20 calculates a key-hitting strength index using one or plurality of the feature quantities, i.e., the maximum size Aₘₐₓ of the contact area, the transient size S_{A} of the contact area A, the maximum time T_{P} to accomplish the maximum size Aₘₐₓ of the contact area, and the total period of time Tₑ, the rising gradient k, the number of times of key hitting, length of the microcomputer in operation, and so on. The index may depend upon the maximum values of the foregoing feature quantities, or may be determined using an index calculating formula composed of a plurality of the feature quantities. A threshold is set for the calculated index.

In step S803, the input device 20 compares the calculated index with the threshold. When the index is larger than the threshold, the input device 20 advances to step S804. Otherwise, the input device 20 goes to step S805.

In step S804, the input device 20 recognizes that the strongly hit keys represent special characters, i.e., upper-case characters.

The input device 20 recognizes that the keys hit with the ordinary strength represent ordinary characters (lower case characters).

With the microcomputer, the input device 20 includes the contact detecting unit 21 (functioning as the contact position detector and the contact strength detector) and the device control IC 23 (as the determining unit), and can detect whether or the user's fingers are simply placed on the contact detecting layer 10a of the touch panel, or the user's fingers are intentionally placed on the contact detecting layer 10a in order to enter information. The feature quantities related to the contact strength are used for this purpose. Further, the information processing method and program are utilized.

The contact strength can be detected on the basis of the size of the contact area or contact pressure. Further, it is possible to accurately detect the contact strength on the basis of the size of the contact area, compared with a case in which the contact state is detected on the basis of a pressure and strength of the key hitting when a conventional pressure sensor type touch panel is used.

When an infrared ray type or an image sensor type touch panel of the related art is used, only a size or a shape of a contact area is detected, so that it is difficult to distinguish “key hitting” and “contact”. The input device 20 of the foregoing embodiment can detect the contact state of the object very easily and accurately.

It is assumed here that an input pen which is relatively hard and smaller than the finger is brought into contact with the contact detecting layer. In this case, the size of the contact area is very small and remains substantially unchanged regardless of the contact pressure. However, the contact strength of the input pen can be reliably detected by estimating time-dependent variations of the size of the contact area.

Up to now, it is very difficult to quickly recognize a plurality of hit keys. The input device 20 of the foregoing embodiment can accurately recognize the hit keys and keys on which the user's fingers are simply placed. Therefore, even when an adept user hits keys very quickly, i.e., a number of keys are hit in an overlapping manner with minute time intervals, the contact states of the hit keys can be accurately recognized.

The device control IC 23 (as the determining section) compares the feature quantities related to the contact strength or values (calculated on the basis of the feature quantities) with the predetermined threshold, which enables the contact state to be recognized. The user may adjust the thresholds in accordance with his or her key hitting habit. If a plurality of users operate the same machine, the device control IC 23 can accurately recognize the contact states taking the users' key hitting habits into consideration. Further, if a user keeps on operating keys for a while, key hitting strength will be changed. In such a case, the user can adjust the threshold as desired in order to maintain a comfortable use environment. Still further, thresholds are stored for individual login users, and then the thresholds will be used for the respective users as initial value.

In the FIG. 4, the display driver 22 (as the display controller) and the display unit 5 can change the indication mode of the input device in accordance with the contact state. For instance, when the virtual keyboard is indicated, the “non-contact”, “contact” or “key hitting” state of the user's fingers can be easily recognized. This is effective in assisting the user to become accustomed to the input device 20. The “contact” state is shown in a manner different from the “non-contact” and “key hitting” states, which enables the user to know whether or not the user's fingers are on the home position keys, and always to place the fingers on the home position.

The brightness of the keys is variable with the contact state, which enables the use of the input device 20 in a dim place. Further, colorful and dynamic indications on the input device will offer side benefits to the user, e.g., joy of using the input device 20, sense of fun, love of possession, feeling of contentment, and so on.

The combination of the input device 20, device control IC 23 (as the announcing section) and speaker 26 can issue the recognition sound on the basis of the relationship between the contact position of the object and the position of the image on the input device 20. This enables the user to know repeated typing errors or an amount of deviation from the center of each key. The user can practice in order to reduce typing errors, and become skillful.

The input device 20 and the device control IC 23 (as the communicating section) notifies the contact state to devices which actually process the information in response to the signal from the input device. For instance, when the user's fingers are placed on the home position, this state will be informed to the terminal device.

The light emitting unit 27 of the input device 20 emits light in accordance with the contact state of the object on the contact detecting layer 10a (FIG. 2). For instance, the user can see and recognize that his or her fingers are on the home position where the keys emit light.

The device control IC 23 (functioning as a special process executing unit can accurately determine the contact state of the object on the input device, and execute the special processes such as the authentication of the object, protection of the devices, protection of the user, and shifting of characters. The device control IC 23 as the special processing section is advantageous in the following respects.

The device control IC 23 can authenticate the object by comparing the feature quantities with the predetermined thresholds. This is effective in preventing the user's classified information from being leaked to anyone else other than the specified parties.

The contact strength threshold is set in order to issue the warning or make the input device 20 inoperative when the object (i.e., the user's finger) comes into contact with the contact detecting layer 10a with strength which may adversely affect the contact detecting layer 10a. This is effective in protecting the microcomputer against problems such as wearing, malfunction, and breakage if the user hits keys excessively or unnecessarily strongly or a beginner hits keys with unnecessary strength.

The contact strength threshold is set in order to issue the warning or make the input device 20 inoperative when the object (i.e., the user) hits keys with strength which may apply unnecessary burdens to the user. This is effective in protecting the user.

Further, the shifting of characters is conducted depending upon whether or not the feature quantities are above the predetermined threshold. For instance, to capitalize the first character of an English word, the user is required only to hit the key strongly. The input device 20 capitalizes it in accordance with the contact strength. Usually, the shift key is hit on the keyboard or a mode of an input/word conversion program, a so-called front end processor, is changed for this purpose. Specifically, the user strongly hits keys which should be capitalized, and hits other keys with the ordinary strength.

### Other Embodiments

Although the invention has been described above with reference to certain embodiments, the invention is not limited to the foregoing embodiment. Modifications and variations of the embodiments described above will occur to those skilled in the art, in the light of the above teachings.

For example, the input unit 3 is integral with the computer main unit 30 in the foregoing embodiment. Alternatively, an external input device may be connected to the computer main unit 30 using a universal serial bus (USB) or the like with an existing connection specification.

FIG. 31 shows an example in which an external input device 20 is connected to the microcomputer main unit, and images of the input device (e.g., a virtual keyboard 25 and a virtual mouse 23) are shown on the display unit (LCD) 5. A USB cable 7 is used to connect the input device 20 to the microcomputer main unit. Information concerning keys hit on the keyboard is transmitted to the microcomputer main unit from the input device 20. The processed data are shown on the display unit connected to the computer main unit.

The input device 20 of FIG. 31 processes the information and shows the virtual keyboard 5a (as shown in FIG. 18 to FIG. 21) as the input unit 3, virtual mouse 5b and so on the display unit 5, similarly to the input device 20 of FIG. 1. Further, the input device 20 executes the special processes shown in FIG. 24, FIG. 25, and FIG. 28 to FIG. 30. These operations may be executed under the control of the microcomputer main unit.

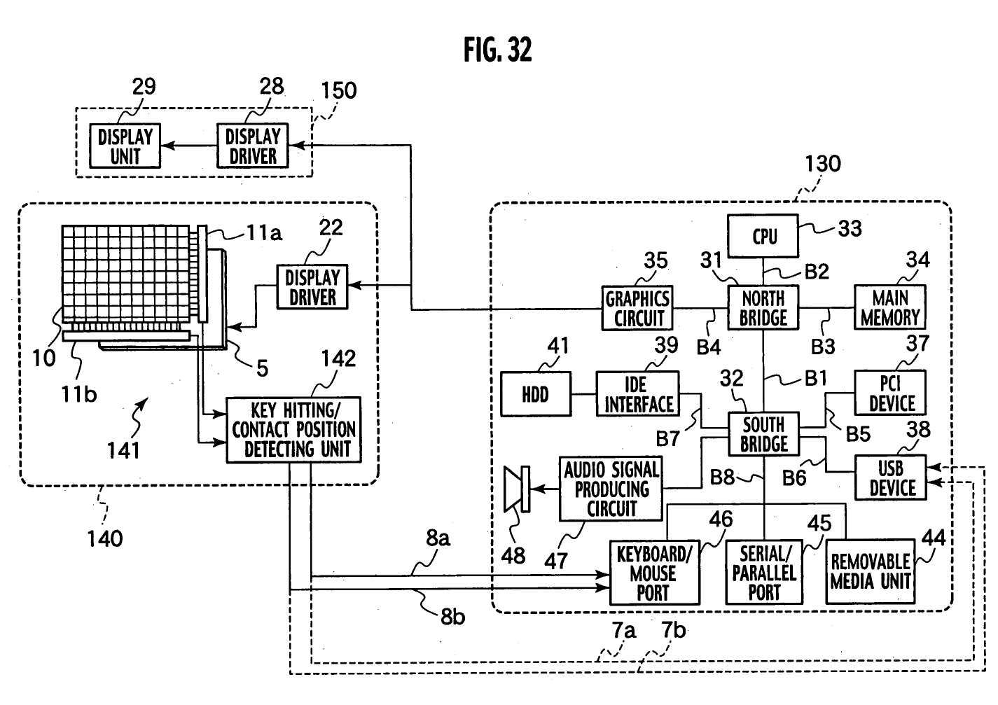

Referring to FIG. 32, a microcomputer main unit 130 is connected to an external input unit 140 provided with an input device 141. The input device 141 receives digital image signals for the virtual keyboard and so on from a graphics circuit 35 (of the microcomputer main unit 130) via a display driver 22. The display driver 22 lets the display unit 5 show images of the virtual keyboard 5a and so on.

A key hitting/contact position detecting unit 142 detects a contact position and a contact state of the object on the contact detecting layer 10a of the touch panel 10, as described with reference to FIG. 18 to FIG. 21. The detected operation results of the virtual keyboard or mouse are transmitted to a keyboard/mouse port 46 of the computer main unit 130 via a keyboard connecting cable (PS/2 cables) or a mouse connecting cable (PS/2 cables).

The microcomputer main unit 130 processes the received operation results of the virtual keyboard or mouse, let the graphics circuit 35 send a digital image signal representing the operation results to a display driver 28 of a display unit 150. The display unit 29 indicates images in response to the digital image signal. Further, the microcomputer main unit 130 sends the digital image signal to the display driver 22 from the graphics circuit 35. Hence, colors and so on of the indications on the display unit 5 (as shown in FIG. 16 and FIG. 17) will be changed. In the foregoing case, the computer main unit 130 functions as the display controller, the contact strength detector, the feature quantity extracting unit and the special process extracting unit. Further, in response to the operation results of the keyboard or mouse, the microcomputer main unit 130 executes the special processes shown in FIG. 24, FIG. 25, and FIG. 28 to FIG. 30. In this case, the microcomputer main unit 130 stores the following information in the main memory 34: the password for the user authentication; reference key hitting pressure; variations of the size of the contact area or history of key hitting time. The operation results of the keyboard or the mouse received from the input unit 140 are compared with the information stored in the main memory 34. On the basis of the compared results, the microcomputer main unit 130 executes the user authentication, protection of the devices or the user, or key shifting shown in FIG. 24, FIG. 25, or FIG. 28 to FIG. 30. If necessary, the alarm will be issued from the speaker 48 via the audio signal output circuit 47, or a digital visual signal will be transmitted from the graphic circuit 35 to the display driver 22 of the input unit 140 or to the display driver 28 of the display unit 150. An image representing the user authentication, protection of the devices or the user, or key shifting is shown on the display panel 29 or the display unit 150 or on the display panel 5 of the input unit 140. Further, audio warnings will be issued from the speaker 48.

Alternatively the operation results of the virtual keyboard and mouse may be sent to the USB device 38 of the microcomputer main unit 130 via USB cables 7a and 7b in place of the keyboard connecting cable and mouse connecting cable, as shown by dash lines in FIG. 32.

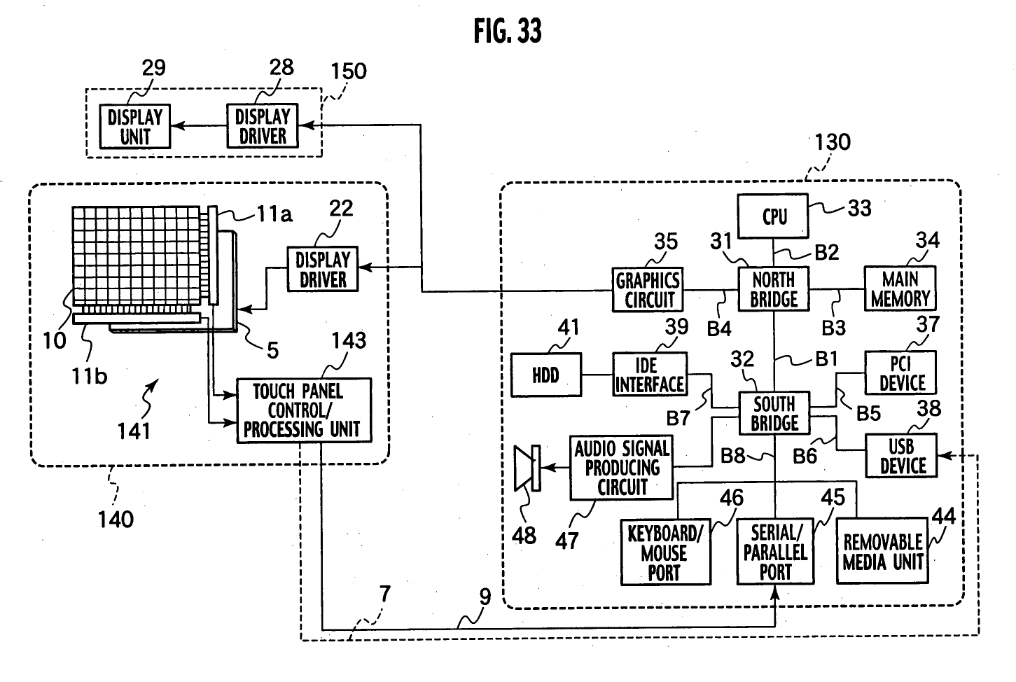

FIG. 33 shows a further example of the external input unit 140 for the microcomputer main unit 130. In the external input unit 140, a touch panel control/processing unit 143 detects keys hit on the touch panel 10, and sends the detected results to the serial/parallel port 45 of the microcomputer main unit 130 via a serial connection cable 9.

The microcomputer main unit 130 recognizes the touch panel as the input unit 140 using a touch panel driver, and executes necessary processing such as changing colors of images of the keyboard shown on the display unit 5, as shown in FIG. 16 and FIG. 17. Further, the microcomputer main unit 130 executes the user authentication, protection of the devices or the user, or key shifting shown in FIG. 24, FIG. 25, or FIG. 28 to FIG. 30. In the foregoing case, the computer main unit 130 functions as the display controller, the contact strength detector, the feature quantity extracting unit and the special process extracting unit.

In the example shown in FIG. 33, the operation state of the touch panel may be sent to the USB device 38 via the USB connecting cable 7 in place of the serial connection cable 9.

In the foregoing embodiment, the touch panel 10 is provided only in the input unit 3. Alternatively, an additional touch panel 10 may be provided in the display unit.

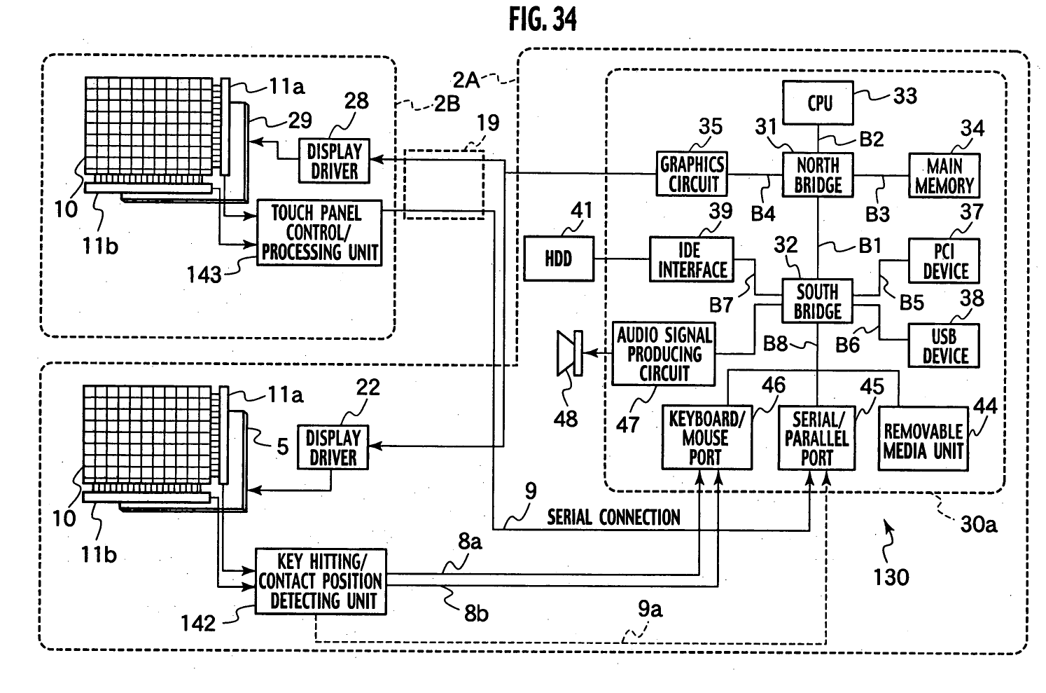

Referring to FIG. 34, the additional touch panel 10 may be installed in the upper housing 2B. Detected results of the touch panel 10 of the upper housing 2B are transmitted to the touch panel control/processing unit 143, which transfers the detected results to the serial/parallel port 45 via the serial connection cable 9.

The microcomputer main unit 130 recognizes the touch panel of the upper housing 2B using the touch panel driver, and performs necessary processing.

Further, the microcomputer main unit 130 sends a digital image signal to a display driver 28 of the upper housing 2B via the graphics circuit 35. Then, the display unit 29 of the upper housing 2B indicates various images. The upper housing 2B is connected to the microcomputer main unit 130 using a signal line via the hinge 19 shown in FIG. 1.

The lower housing 2A includes the key hitting/contact position detecting unit 142, which detects a contact position and a state of the object on the detecting layer 10b of the touch panel 10 as shown in FIG. 18 to FIG. 21, and provides a detected state of the keyboard or mouse to the keyboard/mouse port 46 via the keyboard connection cable 8a (PS/2 cables) or mouse connection cable 8b (PS/2 cables).

The microcomputer main unit 130 provides the display driver 22 (of the input device 140) with a digital image signal on the basis of the operated state of the keyboard or mouse via the graphics circuit 35. The indication modes of the display unit 5 shown in FIG. 16 and FIG. 17 will be changed with respect to colors or the like.

In the foregoing case, the computer main unit 130 functions as the display controller, the contact strength detector, the feature quantity extracting unit and the special process extracting unit.

The operated results of the keyboard or mouse may be transmitted to the serial/parallel port 45 via the serial connection cable 9a in place of the keyboard or mouse connection cable, as shown by dash lines in FIG. 34.

In the lower housing 2A, the key hitting/contact position detecting unit 142 may be replaced with a touch panel control/processing unit 143 as shown in FIG. 34. The microcomputer main unit 130 may recognize the operated results of the keyboard or mouse using the touch panel driver, and perform necessary processing.

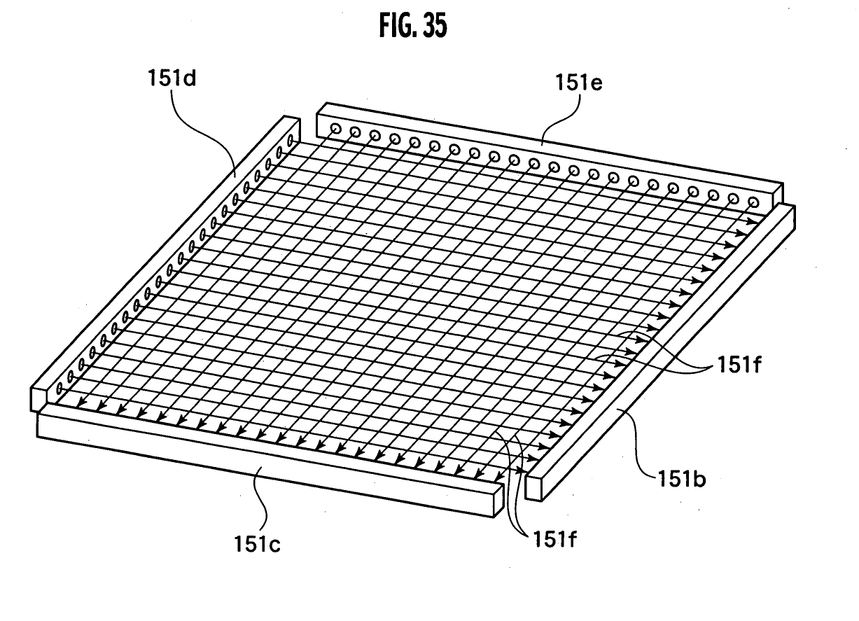

The resistance film type touch panel 10 is employed in the foregoing embodiment. Alternatively, an optical touch panel is usable as shown in FIG. 35. For instance, an infrared ray scanner type sensor array is available.

In the infrared ray scanner type sensor array, light scans from a light emitting X-axis array 151e to a light receiving X-axis array 151c, and from a light emitting Y-axis array 151d to a light receiving Y-axis array 151b. A space where light paths intersect in the shape of a matrix is a contact detecting area in place of the touch panel 10. When the user tries to press the display layer of the display unit 5, the user's finger traverses the contact detecting area first of all, and breaks in a light path 151f. Neither the light receiving X-axis sensor array 151c nor the light receiving Y-axis sensor array 151 receive any light. Hence, the contact detecting unit 21 (shown in FIG. 4) can detect position of the object on the basis of the X and Y coordinates. The contact detecting unit 21 detects strength of the object traversing the contact detecting area (i.e., strength by which the object comes in contact with the display unit 5) and a feature quantity depending upon the strength. Hence, the contact state will be recognized. For instance, when a fingertip having a certain sectional area traverses the contact detecting layer, a plurality of infrared rays are broken out. An increase ratio of the broken infrared rays per unit time depends upon a speed of the fingertip traversing the contact detecting layer. In other word, if strongly pressed onto the display panel, the finger quickly passes over the contact detecting layer. Therefore, it is possible to check whether or not the key is hit strongly in accordance with the number of broken infrared rays. Hence, warning will be shown on the display unit 5 of the input unit 3 on the basis of the checked result.

The portable microcomputer is exemplified as the terminal device. Alternatively, the terminal device may be an electronic databook, a personal digital assistant (PDA), a cellular phone, and so on.

In the flowchart of FIG. 18, the contact position is detected first (step S104), and then the contact strength is detected (step S105). Steps S104 and S105 may be executed in a reversed order. Step S108 (NOTIFYING KEY HITTING), step S109 (INDICATING KEY HITTING) and step S110 (PRODUCING RECOGNITION SOUND) may be executed in a reversed order. The foregoing hold true to the process shown in FIG. 20.

What is claimed is:

1. An input device comprising:
a display unit indicating an image of an input position;
a contact position detecting unit detecting a position of an object brought into contact with a contact detecting layer provided on a display layer of the display unit;
a contact strength detecting unit detecting contact strength of the object brought into contact with the contact detecting layer;
a feature quantity extracting unit extracting a feature quantity related to the detected contact strength; and
an special process executing unit comparing the extracted feature quantity with a predetermined threshold, and executing special processes.

2. The input device of claim 1, wherein the feature quantity relates to the contact strength, variations of the contact strength or a period of contacting time, and the special process executing unit authenticates the object after comparing the extracted feature quantity with the predetermined threshold.

3. The input device of claim 1, wherein: the feature quantity relates to the contact strength or a contact position of the object; the predetermined threshold corresponds to contact strength which adversely affects the contact detecting layer; and the special process executing unit issues a warning or makes the input device inoperative when the feature quantity is larger than the predetermined threshold.

4. The input device of claim 1, wherein: the feature quantity relates to the contact strength or a contact position of the object; the predetermined threshold corresponds to contact strength at which an unnecessary burden is applied to the object; and the special process executing unit issues a warning or makes the input device inoperative when the feature quantity is larger than the predetermined threshold.

5. The input device of claim 1, wherein: the input position is shown as a keyboard; the feature quantity relates to the contact strength, variations of the contact strength or a period of contacting time; and the special process executing unit shifts keys depending upon whether or not the feature quantity is larger than the predetermined threshold.

6. The input device of claim 1 further comprising a contact strength detector which includes first and second bases having electrode layers arranged on opposite surfaces thereof and dot spacers having different levels of height, and detects contact strength of the object brought into contact.

7. A microcomputer comprising:
a display unit indicating an image of an input position;
a contact position detecting unit detecting a position of an object brought into contact with a contact detecting layer provided on a display layer of the display unit;
a contact strength detecting unit detecting contact strength of the object brought into contact with the contact detecting layer;
a feature quantity extracting unit extracting a feature quantity related to the detected contact strength; and
a special process executing unit comparing the extracted feature quantity with a predetermined threshold, and executing special processes.

8. The microcomputer of claim 7, wherein the feature quantity relates to the contact strength, variations of the contact strength or a period of contacting time, and the special process executing unit authenticates the object after comparing the extracted feature quantity with the predetermined threshold.

9. The microcomputer of claim 7, wherein: the feature quantity relates to the contact strength or contact position of the object; the predetermined threshold corresponds to the contact strength which adversely affects the contact detecting layer; and the special process executing unit issues a warning or makes the microcomputer inoperative when the feature quantity is larger than the predetermined threshold.

10. The microcomputer of claim 7, wherein: the feature quantity relates to the contact strength or a contact position of the object; the predetermined threshold corresponds to contact strength at which an unnecessary burden is applied to the object; and the special process executing unit issues a warning or makes the microcomputer inoperative when the feature quantity is larger than the predetermined threshold.

11. The microcomputer of claim 7, wherein: the input position is shown as a keyboard; the feature quantity relates to the contact strength, variations of the contact strength or a period of contacting time; and the special process executing unit shifts keys depending upon whether or not the feature quantity is larger than the predetermined threshold.

12. An information processing method comprising:
indicating an image of an input position on a display unit;
detecting a contact position of an object in contact with a contact detecting layer of the display unit;
detecting contact strength of the object;
extracting a feature quantity related to the detected contact strength; and
comparing the extracted feature quantity with a predetermined threshold and executing special processes on the basis of the compared result.

13. The information processing method of claim 12, wherein the feature quantity relates to the contact strength, variations of the contact strength, or a period of contact time, and authentication of the object is executed by comparing the extracted feature quantity with a predetermined threshold.

14. The information processing method of claim 12, wherein: the feature quantity relates to the contact strength or a contact position of the object; the feature quantity relates to the contact strength which adversely affects the contact detecting layer; and a warning is issued or a process in response to the contacting of the object is suspended when the feature quality is larger than the predetermined threshold.

15. The information processing method of claim 12, wherein: the feature quantity relates to the contact strength or a contact position of the object; the predetermined threshold relates to the contact strength at which an unnecessary burden is applied to the object; and a warning is issued or the process in response to the contacting of the object is suspended when the feature quality is larger than the predetermined threshold.

16. The information processing method of claim 12, wherein: the input position is indicated as a keyboard; the feature quantity relates to the contact strength, variations of the contact strength or a period of contact time; and shifting of characters is conducted when the feature quantity is larger than the predetermined threshold.

17. An information processing program comprising:
indicating an image of an input position on a display unit;
detecting a contact position of an object in contact with a contact detecting layer of the display unit;
detecting contact strength of the object;
extracting a feature quantity related to the detected contact strength; and
comparing the extracted feature quantity with a predetermined threshold and executing special processes on the basis of the compared result.

18. The information processing program of claim 17, wherein the feature quantity relates to the contact strength, variations of the contact strength, or a period of contact time, and authentication of the object is executed by comparing the extracted feature quantity with the predetermined threshold.

19. The information processing program of claim 17, wherein: the predetermined threshold relates to the contact strength or a contact position of the object; the feature quantity relates to the contact strength which adversely affects the contact detecting layer; and a warning is issued or a process in response to the contacting of the object is suspended when the feature quality is larger than the predetermined threshold.

20. The information processing program of claim 17, wherein: the predetermined threshold relates to the contact strength or a contact position of the object; the feature quantity relates to the contact strength which an unnecessary burden is applied to the object; and a warning is issued or a process in response to the contacting of the object is suspended when the feature quality is larger than the predetermined threshold.

21. The information processing program of claim 17, wherein: the input position is indicated as a keyboard; the feature quantity relates to the contact strength, variations of the contact strength or a period of contact time; and shifting of characters is conducted when the feature quantity is larger than the predetermined threshold.
